(19) United States
(12) Patent Application Publication
(10) Pub. No.: US 2026/0141110 A1
(43) Pub. Date: May 21, 2026

(54) ELECTRONIC DEVICE, METHOD, AND NON-TRANSITORY COMPUTER READABLE STORAGE MEDIUM FOR PROVIDING INFORMATION ON PRIVACY SITUATION

(71) Applicant: Samsung Electronics Co., Ltd., Suwon-si (KR)

(72) Inventors: Jeongyong PARK, Suwon-si (KR); Abhijeet Yashawant BORAGULE, Bangalore (IN); Nikhil SAHNI, Bangalore (IN); Pavan Kumar PANAKALAPATI, Bangalore (IN); Renju Chirakarotu NAIR, Bangalore (IN); Sreevatsa Dwaraka BHAMIDIPATI, Bangalore (IN); Dongmin KIM, Suwon-si (KR); Bumhan KIM, Suwon-si (KR); Jungha PAIK, Suwon-si (KR); Kijung JUNG, Suwon-si (KR)

(21) Appl. No.: 19/349,470

(22) Filed: Oct. 3, 2025

Related U.S. Application Data
(63) Continuation of application No. PCT/KR2025/013621, filed on Sep. 3, 2025.

(30) Foreign Application Priority Data
Nov. 21, 2024 (KR) 10-2024-0167804
Dec. 16, 2024 (KR) 10-2024-0187759

(51) Int. Cl. G06F 21/62

(52) U.S. Cl. CPC G06F 21/6245; G06F 2221/2141

(57) ABSTRACT

An electronic device is provided. At least one processor of the electronic device is configured to, in response to detecting use of a permission by an application, obtain a first type of dataset and a second type of dataset related to the use of the permission by the application, identify a first threshold score for respective data included in the first type of dataset and a second threshold score for respective data included in the second type of dataset using a trained artificial intelligence model, identify a first privacy score for the respective data included in the first type of dataset and a second privacy score for the respective data included in the second type of dataset, obtain content for guiding a user to obtain a recommendation for a privacy threat based on a prompt generated using at least one data having a privacy score exceeding the first threshold score among the first type of dataset and at least one data having a privacy score exceeding the second threshold score among the second type of dataset, and display the content for guiding the user to obtain the recommendation for the privacy threat.

### CROSS-REFERENCE TO RELATED APPLICATION(S)

This application is a continuation application, claiming priority under 35 U.S.C. § 365 (c), of an International application No. PCT/KR2025/013621, filed on Sep. 3, 2025, which is based on and claims the benefit of a Korean patent application number 10-2024-0167804, filed on Nov. 21, 2024, in the Korean Intellectual Property Office, and of a Korean patent application number 10-2024-0187759, filed on Dec. 16, 2024, in the Korean Intellectual Property Office, the disclosure of each of which is incorporated by reference herein in its entirety.

### TECHNICAL FIELD

The disclosure relates to an electronic device, a method, and a non-transitory computer-readable storage medium for providing information on a privacy situation.

### BACKGROUND ART

A permission is a means for managing access of an application to a hardware function and/or a software function of an electronic device. For example, the application may use the hardware function and/or the software function of the electronic device based on a granted permission. By using the hardware function and/or the software function of the electronic device based on the granted permission, the application may collect sensitive information of a user. In a case that the sensitive information of the user is collected by the application, privacy of the user may be threatened.

The above information is presented as background information only to assist with an understanding of the disclosure. No determination has been made, and no assertion is made, as to whether any of the above might be applicable as prior art with regard to the disclosure.

### DISCLOSURE

### Technical Solution

Aspects of the disclosure are to address at least the above-mentioned problems and/or disadvantages and to provide at least the advantages described below. Accordingly, an aspect of the disclosure is to provide an electronic device, a method, and a non-transitory computer-readable storage medium for providing information on a privacy situation.

Additional aspects will be set forth in part in the description which follows and, in part, will be apparent from the description, or may be learned by practice of the presented embodiments.

In accordance with an aspect of the disclosure, an electronic device is provided. The electronic device includes a display, memory, including one or more storage media, storing instructions, and at least one processor including processing circuitry, wherein the instructions, when executed by the at least one processor individually or collectively, causes the electronic device to, in response to detecting use of a permission by an application, obtain a first type of dataset and a second type of dataset related to the use of the permission by the application, identify a first threshold score for respective data included in the first type of dataset and a second threshold score for respective data included in the second type of dataset, using a trained artificial intelligence model, identify a first privacy score for the respective data included in the first type of dataset and a second privacy score for the respective data included in the second type of dataset, obtain content for guiding a user to obtain a recommendation for a privacy threat based on a prompt generated using at least one data having a privacy score exceeding the first threshold score among the first type of dataset and at least one data having a privacy score exceeding the second threshold score among the second type of dataset, and display the content for guiding the user to obtain the recommendation for the privacy threat.

In accordance with another aspect of the disclosure, a method performed by an electronic device including a display is provided. The method includes, in response to detecting use of a permission by an application, obtaining a first type of dataset and a second type of dataset related to the use of the permission by the application, identifying a first threshold score for respective data included in the first type of dataset and a second threshold score for respective data included in the second type of dataset using a trained artificial intelligence model, identifying a first privacy score for the respective data included in the first type of dataset and a second privacy score for the respective data included in the second type of dataset, obtaining content for guiding a user to obtain a recommendation for a privacy threat based on a prompt generated using at least one data having a privacy score exceeding the first threshold score among the first type of dataset and at least one data having a privacy score exceeding the second threshold score among the second type of dataset, and displaying the content for guiding the user to obtain the recommendation for the privacy threat.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include, in response to detecting use of a permission by an application, obtaining a first type of dataset and a second type of dataset related to the use of the permission by the application, identifying a first threshold score for respective data included in the first type of dataset and a second threshold score for respective data included in the second type of dataset, using a trained artificial intelligence model, identifying a first privacy score for the respective data included in the first type of dataset and a second privacy score for the respective data included in the second type of dataset, obtaining content for guiding a user to obtain a recommendation for a privacy threat based on a prompt generated using at least one data having a privacy score exceeding the first threshold score among the first type of dataset and at least one data having a privacy score exceeding the second threshold score among the second type of dataset, and displaying the content for guiding the user to obtain the recommendation for the privacy threat.

Other aspects, advantages, and salient features of the disclosure will become apparent to those skilled in the art from the following detailed description, which, taken in conjunction with the annexed drawings, discloses various embodiments of the disclosure.

### DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a simplified block diagram of an electronic device according to an embodiment of the disclosure;

FIG. 3 is a schematic diagram of an artificial intelligence system according to an embodiment of the disclosure;

FIG. 4 illustrates an example of a screen displaying information on permission usage of an application according to an embodiment of the disclosure;

FIG. 5 is a block diagram for describing operations of an electronic device for providing content for a privacy situation according to an embodiment of the disclosure;

FIG. 6 is a flowchart indicating operations of an electronic device for providing content for a privacy situation according to an embodiment of the disclosure;

FIG. 7 is a flowchart indicating operations of an electronic device for refraining from displaying content for an application included in an allow list according to an embodiment of the disclosure;

FIG. 8 is a flowchart indicating operations of an electronic device for setting a permission for an application based on user feedback according to an embodiment of the disclosure;

FIG. 9 illustrates signaling between an electronic device and a server for providing content for a privacy situation according to an embodiment of the disclosure;

FIG. 10 illustrates an example of screens for setting a function to provide content for permission usage of an application according to an embodiment of the disclosure;

FIG. 11 illustrates an example of screens for revoking a permission of an application according to an embodiment of the disclosure;

FIG. 12 illustrates an example of screens displaying a level for a privacy situation according to an embodiment of the disclosure; and

FIG. 13 is a block diagram for describing operations of an electronic device for providing a user with a suggestion to solve a privacy threat according to an embodiment of the disclosure.

Throughout the drawings, like reference numerals will be understood to refer to like parts, components, and structures.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Terms used in the disclosure are used only to describe a specific embodiment, and may not be intended to limit a range of another embodiment. A singular expression may include a plural expression unless the context clearly means otherwise. Terms used herein, including a technical or a scientific term, may have the same meaning as those generally understood by a person with ordinary skill in the art described in the disclosure. Among the terms used in the disclosure, terms defined in a general dictionary may be interpreted as identical or similar meaning to the contextual meaning of the relevant technology and are not interpreted as ideal or excessively formal meaning unless explicitly defined in the disclosure. In some cases, even terms defined in the disclosure may not be interpreted to exclude embodiments of the disclosure.

In various embodiments of the disclosure described below, a hardware approach will be described as an example. However, since the various embodiments of the disclosure include technology that uses both hardware and software, the various embodiments of the disclosure do not exclude a software-based approach.

In addition, in the disclosure, the term ‘greater than’ or ‘less than’ may be used to determine whether a particular condition is satisfied or fulfilled, but this is only a description to express an example and does not exclude description of ‘greater than or equal to’ or ‘less than or equal to.’ A condition described as ‘greater than or equal to’ may be replaced with ‘greater than,’ a condition described as ‘less than or equal to’ may be replaced with ‘less than,’ and a condition described as ‘greater than or equal to and less than’ may be replaced with ‘greater than and less than or equal to.’ In addition, hereinafter, ‘A’ to ‘B’ refers to at least one of elements from A (including A) to B (including B). Hereinafter, ‘C’ and/or ‘D’ means including at least one of ‘C’ or ‘D,’ that is, {‘C,’ ‘D,’ and ‘C’ and ‘D’}.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

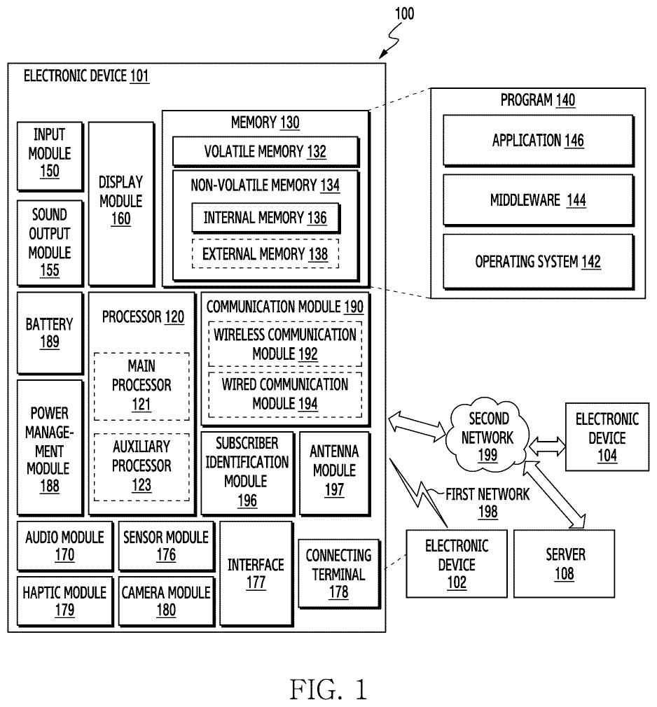

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mm Wave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

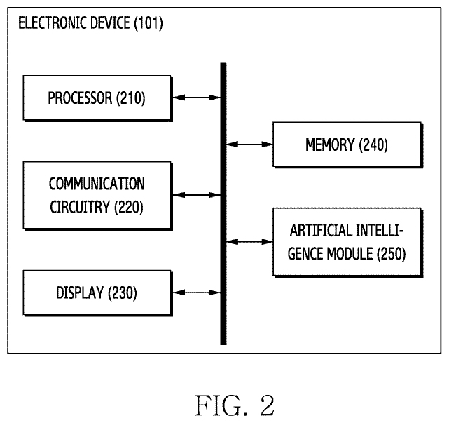

FIG. 2 is a simplified block diagram of an electronic device according to an embodiment of the disclosure.

Referring to FIG. 2, an electronic device 101 of FIG. 2 may include a processor 210, communication circuitry 220, a display 230, memory 240, and an artificial intelligence module 250. For example, the processor 210, the communication circuitry 220, the display 230, the memory 240, and the artificial intelligence module 250 may be electronically and/or operably connected with each other by a communication bus. Hardware components being operably coupled may mean that a direct connection or an indirect connection between the hardware components is established by wire or wirelessly, such that a second hardware component is controlled by a first hardware component among the hardware components. The artificial intelligence module 250 illustrated in FIG. 2 is illustrated as a hardware component, but the disclosure is not limited thereto. For example, the artificial intelligence module 250 may correspond to a software component. The hardware components illustrated in FIG. 2 are illustrated based on different blocks, but the disclosure is not limited thereto. For example, some of the hardware components illustrated in FIG. 2 (e.g., at least a portion of the processor 210, the communication circuitry 220, the display 230, the memory 240, and/or the artificial intelligence module 250) may be included in a single integrated circuit such as a system on chip (SoC) or a system in package (SIP). A type and the number of hardware components included in the electronic device 101 are not limited to what is illustrated in FIG. 2. For example, the electronic device 101 may include only some of the hardware components illustrated in FIG. 2.

In an embodiment, the electronic device 101 may include the processor 210. The processor 210 may include a hardware component for processing data based on one or more instructions. The hardware component for processing data may include, for example, an arithmetic and logic unit (ALU), a floating point unit (FPU), and a field programmable gate array (FPGA). As an example, the hardware component for processing data may include a central processing unit (CPU), a graphics processing unit (GPU), a digital signal processing (DSP), a microcontroller (MCU), and/or a neural processing unit (NPU). The number of processors 210 may be one or more. For example, the processor 210 may have a structure of a multi-core processor such as a dual core, a quad core, or a hexa core. The details of the processor 120 of FIG. 1 may be substantially identically applied to the processor 210 of FIG. 2.

In an embodiment, the processor 210 may include various processing circuitry and/or a plurality of processors. For example, a term “processor” used in this document, including claims, may include various processing circuitry including at least one processor, and one or more of the at least one processor may be configured to perform various functions described below individually and/or collectively in a distributed manner. As used herein, in a case that “processor,” “at least one processor,” and “one or more processors” are described as being configured to perform various functions, these terms encompass, as a non-limiting example, situations in which one processor performs a portion of cited functions and other processor(s) perform another portion of the cited functions, and/or situations in which one processor may perform all of the cited functions. Additionally, the at least one processor may include a combination of processors that perform enumerated/disclosed various functions, for example, in a distributed manner. The at least one processor may execute program instructions to achieve or perform the various functions.

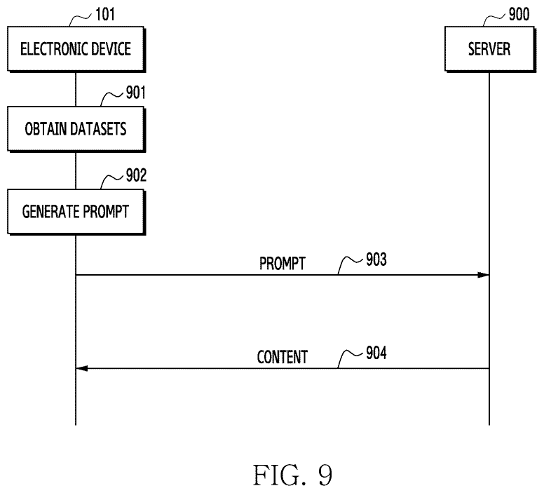

In an embodiment, the electronic device 101 may include the communication circuitry 220. The communication circuitry 220 may include circuitry for supporting transmission and/or reception of an electrical signal between the electronic device 101 and an external electronic device (e.g., a server 900 of FIG. 9) different from the electronic device 101. The communication circuitry 220 may include at least one of a modem, an antenna, and an optic/electronic (O/E) converter. The communication circuitry 220 may support transmission and/or reception of an electrical signal based on various types of communication means such as Ethernet, Bluetooth, Bluetooth low energy (BLE), ZigBee, a long term evolution (LTE), and/or 5G new radio (NR). The details of the communication module 190 and/or the antenna module 197 of FIG. 1 may be substantially identically applied to specific details of the communication circuitry 220 of FIG. 2.

In an embodiment, the electronic device 101 may include the display 230. The display 230 may include a display panel, a touch sensor, and/or processing circuitry. In an embodiment, the display panel may be used to display visual information (e.g., an image, a screen, an object, a user interface (UI), a graphic user interface (GUI), and/or a visual object). For example, the display panel may have a display area capable of receiving a touch input. In an embodiment, the touch sensor may be used to obtain data on an external object positioned on the display panel. For example, the touch sensor may be positioned in the display panel or on the display panel to provide an area of the display panel capable of receiving a touch input. For example, the touch sensor may be configured to obtain data on contact points on at least a portion of the area. In an embodiment, the processing circuitry may control the touch sensor. For example, the processing circuitry may process signals or data obtained (or received) through the touch sensor. The details of the display module 160 of FIG. 1 may be substantially identically applied to specific details of the display 230 of FIG. 2.

In an embodiment, the electronic device 101 may include the memory 240. The memory 240 may include a hardware component for storing data and/or instructions inputted to the processor 210 and/or outputted from the processor 210. For example, the memory 240 may include volatile memory such as random-access memory (RAM), and/or non-volatile memory such as read-only memory (ROM). The volatile memory may include, for example, at least one of dynamic RAM (DRAM), static RAM (SRAM), Cache RAM, or pseudo SRAM (PSRAM). The non-volatile memory may include, for example, at least one of programmable ROM (PROM), erasable PROM (EPROM), electrically erasable PROM (EEPROM), flash memory, a hard disk, a compact disk, or an embedded multimedia card (eMMC).

In an embodiment, in the memory 240 of the electronic device 101, one or more instructions (or commands) indicating a calculation and/or operation performed by the processor 210 of the electronic device 101 may be stored. A set of one or more instructions may be referred to as a program, firmware, an operating system, a process, a routine, a sub-routine, and/or an application. Hereinafter, being installed in the electronic device 101 may mean that one or more instructions provided in a form of an application are stored in the memory 240, and the one or more applications a stored in a format executable by the processor 210 of the electronic device 101. The details of the memory 130 of FIG. 1 may be substantially identically applied to specific details of the memory 240 of FIG. 2.

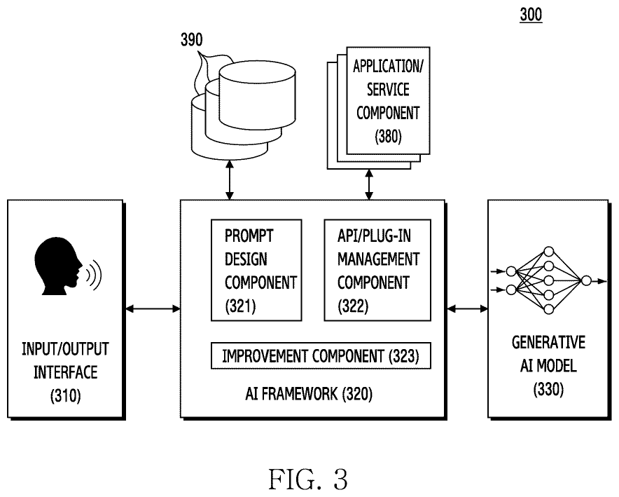

In an embodiment, the electronic device 101 may include the artificial intelligence module 250. The artificial intelligence module 250 may be a unit (functional code, separate device, circuitry, or set of instructions) for performing functions. For example, the artificial intelligence module 250 may be a unit (functional code, separate device, circuitry, or set of instructions) for a large language model (LLM), a variational auto-encoder (VAE), a graph-based artificial intelligence model, a long short-term memory (LSTM)-based artificial intelligence model, a support vector machine (SVM)-based artificial intelligence model, a transformer-based artificial intelligence model, or a combination thereof (e.g., an ensemble method). For example, the artificial intelligence module 250 may be referred to as an artificial intelligence model or another term having an equivalent technical/functional meaning. Details of an artificial intelligence system 300 of FIG. 3 may be substantially identically applied to specific details of the artificial intelligence module 250 of FIG. 2.

FIG. 3 is a schematic diagram of an artificial intelligence system according to an embodiment of the disclosure.

Referring to FIG. 3, an artificial intelligence (AI) system 300 may include an input/output interface 310, an AI framework 320, a generative AI model 330, and/or a knowledge repository 390. The artificial intelligence system of FIG. 3 may be replaced by an artificial intelligence model, an artificial intelligence module, or another term having an equivalent technical meaning.

The input/output interface 310 may receive an input. The input may include user input and/or data obtained or generated by an electronic device (e.g., the electronic device 101 described above). The data may include an image, a video, and/or sensor data (e.g., illuminance data around the electronic device 101 or posture data (or orientation data) of the electronic device 101 obtained from a sensor or a sensor hub (e.g., an auxiliary processor 123)) generated by at least one processor (e.g., a processor 210) of the electronic device 101, temperature inside the electronic device 101 (e.g., temperature of a display 230 or temperature of the at least one processor 210), size information of a display area of the display 230, and/or an image obtained through an image sensor (e.g., included in a camera module 180) of the electronic device 101. The user input may include natural language, touch data obtained through touch circuitry (e.g., used to identify an input from a finger and/or a stylus) included in a display module 160, an image displayed (and/or to be displayed) on the display module 160, and/or a video. As a non-limiting example, the user input may be received by the input/output interface 310 together with context information. The context information may be described as additional information obtained in relation to the user input. The context information may be related to a state (e.g., including a state of the electronic device 101 and/or a state around the electronic device 101 (e.g., a user state)) when the user input is received. For example, the context information may include information on one or more software applications executed in the electronic device 101 when the user input is received. For example, the context information may include information on a position of the electronic device 101 (or a position of a user of the electronic device 101) when the user input is received. For example, the user input may be integrated with the context information. For example, the user input integrated with the context information by the input may be received by the input/output interface 310.

The input/output interface 310 may transmit (or provide) an output. The output may include a result (or result information) generated or obtained by the AI system 300 based at least in part on the input. A format of the output may vary. For example, the output may include natural language. For example, the output may include content (e.g., including media content and/or multimedia content). For example, the output may include an action related to the user of the electronic device 101. For example, the output may have a format in accordance with a user setting of the electronic device 101. For example, the input/output interface 310 may be described as a user query/response interface 310.

The AI framework 320 may be used to obtain information (or data) on the input from the input/output interface 310 and control one or more components related to the AI system 300 using the obtained information.

For example, a prompt design component 321 in the AI framework 320 may generate or obtain a prompt for the generative AI model 330 (e.g., including a large language model (LLM), a large vision model (LVM), and/or a large multimodal model (LMM)) using the obtained information. For example, the prompt design component 321 may be described as an AI component using a learning algorithm and/or a neural network to provide an enhanced prompt over time. For example, the prompt design component 321 may generate or obtain a prompt by accessing a knowledge component (e.g., the knowledge repository 390) including user preference data, a prompt library, and/or a prompt example using the obtained information. The generated prompt may be provided to the generative AI model 330 (e.g., including the LLM or the LMM).

For example, an API/plug-in management component 322 in the AI framework 320 may be used to support communication for additional information requested (or caused) in relation to the prompt provided (or to be provided) to the generative AI model 330. For example, the API/plug-in management component 322 may be used to generate or establish a channel for communication with various data sources (e.g., the knowledge repository 390). For example, the API/plug-in management component 322 may support access to at least a portion of the data sources. For example, the API/plug-in management component 322 may be used to request another component (e.g., an application/service component 380) to perform feedback (or response) in accordance with the prompt. As a non-limiting example, information obtained (or generated) through the API/plug-in management component 322 may be provided to the prompt design component 321 to generate a prompt. As a non-limiting example, the information obtained (or generated) through the API/plug-in management component 322 may be provided to the generative AI model 330.

For example, an improvement component 323 in the AI framework 320 may at least partially tune (or adjust) (or change) a result (e.g., content) obtained (or outputted) from the generative AI model 330. For example, the improvement component 323 may determine or verify whether the content obtained from the generative AI model 330 is related to the input. For example, the improvement component 323 may determine or verify whether the content obtained from the generative AI model 330 includes biased content. For example, the improvement component 323 may determine or verify whether the content obtained from the generative AI model 330 includes harmful content. For example, the improvement component 323 may support or assist in performing additional processing to improve the content obtained from the generative AI model 330. For example, the improvement component 323 may support providing a hint to the user to improve the content.

The generative AI model 330 may be described as an artificial intelligence neural network that generates feedback in response to a prompt. For example, the feedback may be related to the prompt, but may further include additional data and/or information relative to the prompt. For example, the feedback may include new content relative to the prompt. For example, the generative AI model 330 may include a model that generates an image and/or a model that generates a language. For example, the model that generates an image may include a generative adversarial network (GAN) and/or a variational auto-encoder (VAE). For example, the model that generates an image may include a diffusion-based generative model (e.g., a transformer VAE). For example, the generative AI model 330 may include an LMM that generates the feedback by recognizing text, an image, and/or voice.

As a non-limiting example, the AI framework 320 and/or the generative AI model 330 may be included in an artificial intelligence module 250 (e.g., including processing circuitry) in the electronic device 101. For example, the artificial intelligence module 250 may be operably coupled with at least one processor (e.g., the at least one processor 210 or the processor 120) of the electronic device 101. For example, the artificial intelligence module 250 may be operably coupled with display driving circuitry of the electronic device 101. For example, the artificial intelligence module 250 may be operably coupled with the sensor hub of the electronic device 101 for one or more sensors in the electronic device 101.

Some of operations described below may be executed (or performed) through the artificial intelligence system described with reference to FIG. 3.

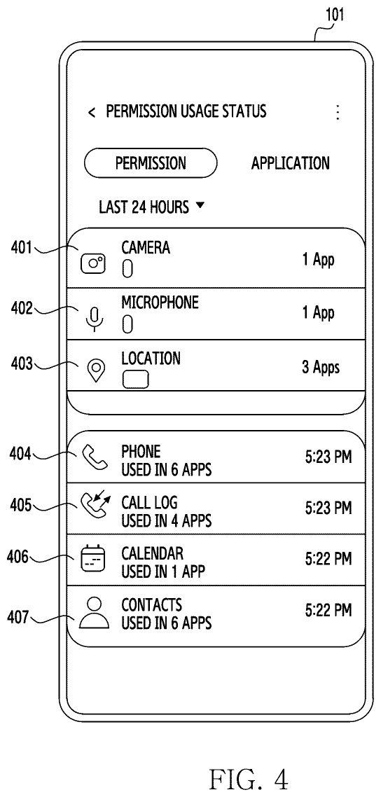

FIG. 4 illustrates an example of a screen displaying information on permission usage of an application according to an embodiment of the disclosure. A permission is a means to manage access of an application to a hardware function and/or a software function of an electronic device 101. For example, the application may use the hardware function and/or the software function in accordance with a granted permission. In an example, permissions may include a camera permission, a microphone permission, a location permission, an access permission to a nearby device, a call log permission, a calendar permission, and/or a photo/video permission. However, this is only an example, and the disclosure is not limited thereto. For example, a permission may further include another permission other than the examples described above.

Referring to FIG. 4, the electronic device 101 may display, through a display 230, contents for permissions used by applications for a designated time (e.g., 24 hours). A screen displayed through the display 230 may include first content 401, second content 402, third content 403, fourth content 404, fifth content 405, sixth content 406, and seventh content 407.

For example, the first content 401 may include information on a camera permission. The first content 401 may include an image indicating the camera permission, text indicating the camera permission, a chart indicating the number of applications using the camera permission, and text indicating the number of applications using the camera permission. For example, the second content 402 may include information on a microphone permission. The second content 402 may include an image indicating the microphone permission, text indicating the microphone permission, a chart indicating the number of applications using the microphone permission, and text indicating the number of applications using the microphone permission. For example, the third content 403 may include information on a location permission. The third content 403 may include an image indicating the location permission, text indicating the location permission, a chart indicating the number of applications using the location permission, and text indicating the number of applications using the location permission. For example, some permission(s) among permissions (e.g., a nearby device permission, a microphone permission, a photo and video permission, a body sensor permission, a physical activity permission, a notification permission, a contact permission, a location permission, a music and audio permission, a phone permission, a camera permission, a calendar permission, a call log permission, a file permission, and a short message service (SMS) permission) may be displayed separately from other permissions in a partial area of the screen displayed through display 230. In an example, the separately displayed permissions may be pre-designated permissions (e.g., a camera permission, a microphone permission, and a location permission). In an example, the separately displayed permissions, which are accessible to sensitive information of a user, may include permissions (e.g., a file permission) related to a special permission, permissions (e.g., a phone permission, a physical activity permission) related to a device administrator, permissions (e.g., an SMS permission) related to SMS, and/or permissions (e.g., a file permission, a music and audio permission) related to a battery. However, this is only an example, and the disclosure is not limited thereto. For example, the separately displayed permissions may be set by the user.

For example, the fourth content 404 may include information on a phone permission. The fourth content 404 may include an image indicating the phone permission, text indicating the phone permission, text indicating the number of applications using the phone permission, and text indicating a recent time the phone permission was used. For example, the fifth content 405 may include information on a call log permission. The fifth content 405 may include an image indicating the call log permission, text indicating the call log permission, text indicating the number of applications using the call log permission, and text indicating a recent time the call log permission was used. For example, the sixth content 406 may include information on a calendar permission. The sixth content 406 may include an image indicating the calendar permission, text indicating the calendar permission, text indicating the number of applications using the calendar permission, and text indicating a recent time the calendar permission was used. For example, the seventh content 407 may include information on a contact permission. The seventh content 407 may include an image indicating the contact permission, text indicating the contact permission, text indicating the number of applications using the contact permission, and text indicating a recent time the contact permission was used.

As illustrated in FIG. 4, the electronic device 101 may list information on permissions. For example, the electronic device 101 may provide information on a privacy situation to the user by displaying, through the display 230, information indicating applications using a permission, information on the number of applications using the permission, and/or information on a recent time the permission was used. For example, the privacy situation may indicate a situation in which personal information and/or sensitive information of the user collected by permission usage of an application may be transmitted to a third party other than the user. In addition, the privacy situation may indicate a situation in which a permission is used by an application contrary to an intention of the user, or the corresponding permission is used by the application in a state in which the permission does not need to be used. In an example, the privacy situation may include a situation in which an application recommends a restaurant near the user by using the location permission without explicit consent of the user. In an example, the privacy situation may include a situation in which a photo editing application uses the camera permission while the user is not taking a photo. The user may check the privacy situation based on the information listed on the screen displayed through the display 230. However, a user with insufficient prior knowledge for the privacy situation may have difficulty understanding the information listed on the screen. In addition, even a user with sufficient prior knowledge for the privacy situation may have difficulty identifying important information among the information listed on the screen. Therefore, the user may fail to recognize an occurrence of a privacy threat situation in which personal information and/or sensitive information is leaked. In order to solve the above-described problem, an electronic device, a method, and a non-transitory computer-readable storage medium for providing summary information on the privacy situation using an artificial intelligence model are described below.

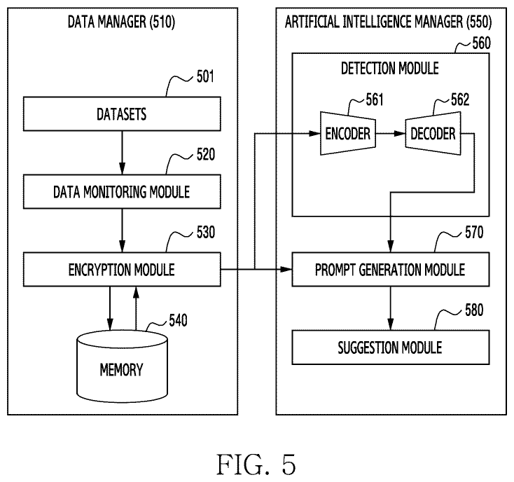

FIG. 5 is a block diagram for describing operations of an electronic device for providing content for a privacy situation according to an embodiment of the disclosure. Hereinafter, terms ‘manager’ or ‘module’ may mean a unit implemented as hardware or software for performing a designated function. The ‘manager’ or ‘module’ may be referred to as logic, a logic block, a component, circuitry, or another term having an equivalent technical/functional meaning.

Referring to FIG. 5, an electronic device 101 may include a data manager 510 and an artificial intelligence manager 550. The data manager 510 may include a data monitoring module 520, an encryption module 530, and/or memory 540. The artificial intelligence manager 550 may include a detection module 560, a prompt generation module 570, and/or a suggestion module 580. For example, components exemplified in FIG. 5 may be implemented as a portion of the hardware components (e.g., the processor 210, the communication circuitry 220, the display 230, the memory 240, and/or the artificial intelligence module 250) exemplified in FIG. 2.

In an embodiment, the electronic device 101 may include the data monitoring module 520. The data monitoring module 520 may collect (or obtain) datasets 501. For example, the datasets 501 may mean a set of data collected (or obtained) while an application uses a permission. For example, the datasets 501 may be obtained by extracting a portion of monitoring datasets. In an example, a monitoring dataset and a dataset may be as shown in Table 1 below.

TABLE 1

| | |
|---|---|
| Monitoring | 06-23 21:59:00.713 16467 16467: android:camera \| |
| dataset | com.sec.android.app.camera \| true |
| | 06-23 21:59:05.240 16467 16467: android:camera \| |
| | com.sec.android.app.camera \| false |
| Dataset | 06-23 21:59:00 16467 permission: camera 1 |
| | 06-23 21:59:05 16467 permission: camera 0 |

In Table 1, the dataset may be obtained (or collected) by extracting time (e.g., 06-23 21:40:00) at which the corresponding data was obtained, an application (e.g., 16467), a permission used by the application (e.g., permission: camera), and whether the permission was used (e.g., 1 or 0), from among the monitoring dataset. However, Table 1 is only an example for description, and the disclosure is not limited thereto. The electronic device 101 may obtain a dataset from a monitoring dataset according to various methods. Hereinafter, ‘data’ included in the datasets means an independent type of data. The ‘data’ may be referred to as a data instance, a data item, a data element, a data sample, or another term having an equivalent technical meaning.

In an embodiment, the datasets 501 may include a plurality of types of data. A first type (e.g., a critical permission) of data may include data indicating a permission granted to an application among permissions (e.g., a nearby device permission, a microphone permission, a photo and video permission, a body sensor permission, a physical activity permission, a notification permission, a contact permission, a location permission, a music and audio permission, a phone permission, a camera permission, a calendar permission, a call log permission, a file permission, and a short message service (SMS) permission). A second type (e.g., a permission status) of data may include data indicating whether the permission(s) granted to the application is granted by a request of the application or by a user. A third type (e.g., an application) of data may include data indicating a source (or an install path) of the application, data indicating the number of executions of the application, data indicating usage time of the application, data indicating a category of the application, data indicating a trust level of the application, data indicating whether the application is executed in a foreground (or a background), and/or data indicating permission access time of the application. A fourth type (e.g., user context) of data may include data indicating whether user input is obtained. A fifth type (e.g., a device status) of data may include data indicating central processing unit (CPU) usage time, data indicating power usage, and/or data indicating network usage. The datasets 501 may include at least a portion of the above-described data. In addition, the above-described data is only an example, and the disclosure is not limited thereto. The datasets 501 may further include data other than the above-described example. In a non-limiting example, the datasets 501 may further include data (e.g., sensor data of a watch, microphone data of a remote controller, and camera data of a robot vacuum cleaner) of a wearable device connected to the electronic device 101.

In an embodiment, the datasets 501 may include a first type (e.g., binary) of dataset, a second type (e.g., numerical) of dataset, and/or a third type (e.g., categorical) of dataset. In an example, the first type of dataset may include data indicating whether the application is executed in the foreground (or the background), data indicating whether a permission of the application is granted by a request of the application or by the user, and/or data indicating whether user input is obtained. In an example, the second type of dataset may include data indicating the number of executions of the application, data indicating usage time of the application, data indicating the permission granted to the application, data indicating power usage, data indicating network usage, data indicating permission access duration of the application, and/or data indicating CPU usage time. In an example, the third type of dataset may include category data of the application, data for a trust level of the application, and/or data for a source (or an install path) of the application. However, this is only an example, and the disclosure is not limited thereto. The above-described data may be classified into one of the first type of dataset, the second type of dataset, or the third type of dataset in accordance with a method of representing the data.

In an embodiment, the data monitoring module 520 may perform preprocessing on collected datasets. For example, the preprocessing may include missing value processing for biased data, outlier processing, data normalization, and/or data type conversion. The electronic device 101 may provide the preprocessed datasets to the encryption module 530.

In an embodiment, the electronic device 101 may include the encryption module 530. The encryption module 530 may perform encryption on the preprocessed datasets. For example, the encryption may be performed in a secure area different from an area for performing general data processing. In an example, the secure area may include a trusted execution environment (TEE), an embedded secure element (eSE), and/or a secure processor. However, the disclosure is not limited thereto. The encryption module 530 may store encrypted datasets in the memory 540. The encryption module 530 may periodically obtain the encrypted datasets (current datasets and/or previously obtained datasets) from the memory 540. The encryption module 530 may perform decryption on the encrypted datasets obtained from the memory 540. The encryption module 530 may provide the decrypted datasets to the detection module 560 and/or the prompt generation module 570.

In an embodiment, the electronic device 101 may include the detection module 560. The detection module 560 may include an encoder 561 for outputting a mean and a standard deviation for respective data included in the datasets and a decoder 562 for outputting a threshold score for the respective data included in the datasets based on the output of the encoder 561. For example, the encoder 561 may be composed of a plurality of convolution layers and dense layers. For example, the decoder 562 may be composed of a plurality of convolution layers and dense layers. In an example, a trained artificial intelligence model used in the detection module 560 may be a variational auto-encoder (VAE) including the encoder 561 and the decoder 562. However, this is only an example, and the disclosure is not limited thereto. For example, the trained artificial intelligence model used in the detection module 560 may be a large language model (LLM), a conditional VAE, a long short-term memory (LSTM)-based artificial intelligence model, a support vector machine (SVM)-based artificial intelligence model, a transformer-based artificial intelligence model, or a combination thereof (e.g., an ensemble method). In an example, the trained artificial intelligence model may be the LLM. The electronic device 101 may lighten an on-device model and increase efficiency of fine-tuning for the LLM by using only the LLM in operations in accordance with the disclosure.

In an embodiment, the detection module 560 may be based on a multi-stream method to enable accurate prediction by separately learning a categorical dataset and a numerical dataset. In an example, since the first type (e.g., binary) of dataset may be classified into both the categorical dataset and the numerical dataset, the first type (e.g., binary) of dataset may be provided as an input to the encoder 561 through a first stream and/or a second stream. In an example, the second type (e.g., numerical) of the dataset may be provided as an input to the encoder 561 through the first stream. In an example, the third type (e.g., categorical) of dataset may be provided as an input to the encoder 561 through the second stream. However, this is only an example for description, and the disclosure is not limited thereto.

In an embodiment, the detection module 560 may identify (or obtain) the mean and the standard deviation for the respective data of the datasets, based on the datasets. The detection module 560 may identify (or generate) a privacy score for the respective data based on the mean and the standard deviation. For example, the privacy score is a numerical value indicating a degree of normality or abnormality of an event associated with the data. The privacy score may indicate a privacy threat level of the corresponding data. The privacy threat level may indicate a degree of sensitivity of information accessed by permission usage of the application and/or a possibility of leakage of information accessed by the permission usage of the application. In an example, as the privacy threat level increases, the degree of sensitivity of information and/or the possibility of information leakage may also increase. In an example, the privacy score, which is a standard value (or a standard score, a Z-score, or a Z-value) of a value indicated by the data, may be identified (or generated) according to Equation 1 below.

$$z = \frac{x - μ}{σ} \qquad Equation 1$$

z indicates a standard value. x indicates a value indicated by the data. μ indicates a mean value for the corresponding data. σ indicates a standard deviation of the corresponding data.

In a non-limiting example, a correlation value between permissions may be further used in addition to the mean and the standard deviation of the data to identify (or generate) the privacy score. For example, the correlation value may indicate a correlation between a plurality of permissions (e.g., a camera permission, a microphone permission, a location permission, an access permission to a nearby device, a short message service (SMS) permission, a contact permission, a music/audio permission, a call log permission, a calendar permission, a photo/video permission). In an example, the correlation value between a plurality of permissions may be pre-designated. In an example, a correlation value between the camera permission and the photo/video permission may be relatively high. Therefore, in a case that an application uses both the camera permission and the photo/video permission, which have a high correlation, a possibility of a privacy threat situation occurring may be relatively low. In an example, a correlation value between the contact permission and the music/audio permission may be relatively low. Therefore, in a case that an application uses both the contact permission and the music/audio permission, which have a low correlation, a possibility of a privacy threat situation occurring may be relatively high. However, this is only an example for description, and the disclosure is not limited thereto.

In an embodiment, the detection module 560 may identify (or generate) the threshold score for the respective data included in the datasets based on the output of the encoder 561. For example, the threshold score may be used to identify input data for generating a prompt. In an example, data having a privacy score exceeding the threshold score may be identified as the input data for generating the prompt. In another example, data having a privacy score below the threshold score may not be identified as the input data for generating the prompt. For example, a different loss function may be used to identify (or generate) the threshold score in accordance with a type of the datasets. In an example, a first loss function (e.g., binary cross entropy) may be used to obtain a first threshold score for respective data included in the first type (e.g., binary) of dataset. In an example, a second loss function may be used to obtain a second threshold score for respective data included in the second type (e.g., numerical) of dataset. In an example, a third loss function (e.g., categorical cross entropy) may be used to obtain a third threshold score for respective data included in the third type (e.g., categorical) of dataset.

In an embodiment, the detection module 560 may provide a privacy score and a threshold score for the respective data included in the datasets to the prompt generation module 570.

In an embodiment, the electronic device 101 may include the prompt generation module 570. The prompt generation module 570 may identify at least one data having a privacy score exceeding the threshold score among the datasets obtained from the encryption module 530. The prompt generation module 570 may generate a prompt based on the identified at least one data and/or the privacy score corresponding to the identified at least one data. The prompt generation module 570 may provide the generated prompt to the suggestion module 580.

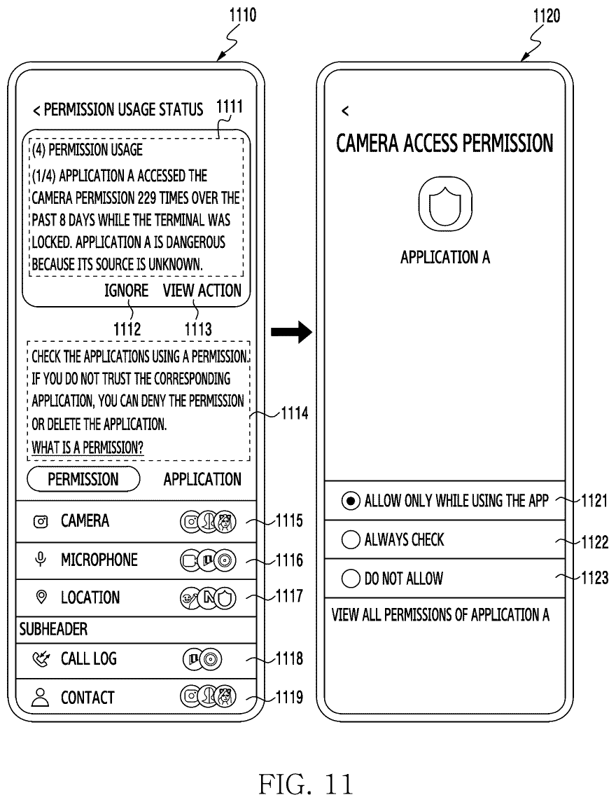

In an embodiment, the electronic device 101 may include the suggestion module 580. The suggestion module 580 may generate content (or privacy context information) for guiding the user to obtain (or display) a recommendation for a privacy threat based on the prompt obtained from the prompt generation module 570. For example, the content may be for providing the user with a notification for the recommendation. For example, a language model (e.g., a large language model (LLM)) may be used to generate the content based on the prompt. The language model may be fine-tuned using low-rank adaptation (LoRA). The suggestion module 580 may display the generated content through the display 230. The content may include a message for guiding the user to obtain (or display) the recommendation for the privacy threat, an object for dismissing the content, and/or an object for displaying a setting screen for the corresponding permission of the application. For example, the electronic device 101 may obtain user input (e.g., touch input) for the object for dismissing the content. For example, in response to obtaining the user input for the object for dismissing the content, the electronic device 101 may not display the content through the display 230. For example, in response to obtaining the user input for the object for dismissing the content, the electronic device 101 may add the corresponding application to an allow list. After adding the application to the allow list, the electronic device 101 may refrain from generating content indicating a privacy situation for the application. For example, refraining from generating content may mean not generating content. The electronic device 101 may prevent privacy context information not requested by the user from being displayed through the display 230 by refraining from generating content for an application included in the allow list. For example, the electronic device 101 may display a screen (e.g., a screen 1120 of FIG. 11) for activating/deactivating settings (e.g., allow only while using the app, always check, and/or do not allow) for a permission of an application based on obtaining user input for a UI for displaying the setting screen for the corresponding permission of the application.

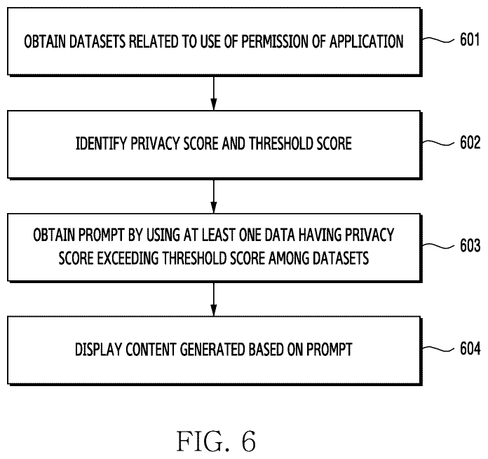

FIG. 6 is a flowchart indicating operations of an electronic device for providing content for a privacy situation according to an embodiment of the disclosure. The operations of FIG. 6 may be performed by the electronic device 101 of FIGS. 1 and 2. For example, at least some of the operations may be controlled by a processor 210 of the electronic device 101. Hereinafter, each operation may be performed sequentially, but is not necessarily performed sequentially. For example, an order of each operation may be changed. For example, at least two operations may be performed in parallel. Hereinafter, ‘data’ included in datasets means an independent type of data. The ‘data’ may be referred to as a data instance, a data item, a data element, a data sample, or another term having an equivalent technical meaning.

Referring to FIG. 6, in operation 601, the electronic device 101 according to an embodiment may obtain datasets related to use of a permission of an application. For example, the datasets may mean a set of data collected (or obtained) while the application uses the permission. In an example, the permission may be one of a camera permission, a microphone permission, a location permission, an access permission to a nearby device, a short message service (SMS) permission, a contact permission, a music/audio permission, a call log permission, a calendar permission, and a photo/video permission. However, this is only an example, and the disclosure is not limited thereto. The permission may be another permission other than the examples described above. The electronic device 101 may obtain datasets related to the use of the permission of the application in an active state, an idle state, and/or a sleep state. For example, the electronic device 101 may monitor the datasets not only in the active state, but also in the idle state and/or in the sleep state.

In an embodiment, datasets 501 may include a plurality of types of data. A first type (e.g., a critical permission) of data may include data indicating a permission granted to an application among permissions (e.g., a nearby device permission, a microphone permission, a photo and video permission, a body sensor permission, a physical activity permission, a notification permission, a contact permission, a location permission, a music and audio permission, a phone permission, a camera permission, a calendar permission, a call log permission, a file permission, and a short message service (SMS) permission). A second type (e.g., a permission status) of data may include data indicating whether the permission(s) granted to the application is granted by a request of the application or by a user. A third type (e.g., an application) of data may include data indicating a source (or an install path) of the application, data indicating the number of executions of the application, data indicating usage time of the application, data indicating a category of the application, data indicating a trust level of the application, data indicating whether the application is executed in a foreground (or a background), and/or data indicating permission access duration of the application. A fourth type (e.g., user context) of data may include data indicating whether user input is obtained. A fifth type (e.g., a device status) of data may include data indicating central processing unit (CPU) usage time, data indicating power usage, and/or data indicating network usage. The datasets 501 may include at least a portion of the above-described data. In addition, the above-described data is only an example, and the disclosure is not limited thereto. The datasets 501 may further include data other than the above-described examples. In a non-limiting example, the datasets 501 may further include data (e.g., sensor data of a watch, microphone data of a remote controller, and camera data of a robot vacuum cleaner) of a wearable device connected to the electronic device 101.

In an embodiment, the datasets may include a first type (e.g., binary) of dataset, a second type (e.g., numerical) of dataset, and/or a third type (e.g., categorical) of dataset. In an example, the first type of dataset may include data indicating whether the application is executed in the foreground (or background), data indicating whether the permission of the application is granted by a request of the application or by the user, and/or data indicating whether user input is obtained. In an example, the second type of dataset may include data indicating the number of executions of the application, data indicating usage time of the application, data indicating the permission granted to the application, data indicating power usage, data indicating network usage, data indicating permission access duration of the application, and/or data indicating CPU usage time. In an example, the third type of dataset may include category data of the application, data for a trust level of the application, and/or data for a source (or an install path) of the application. However, this is only an example, and the disclosure is not limited thereto. The above-described data may be classified into one of the first type of dataset, the second type of dataset, or the third type of dataset in accordance with a method of representing the data.

In an embodiment, the second type (e.g., numerical) of dataset may include data indicating the permission granted to the application. The electronic device 101 may perform a conversion to represent the data indicating the permission granted to the application into a numerical form. The data indicating the permission granted to the application may be classified into the second type (e.g., numerical) of dataset based on the conversion. In an example, permissions granted to the application may be grouped as shown in Table 2 below. However, this is only an example for description, and the disclosure is not limited thereto.

TABLE 2

| Group | Permission |
|---|---|
| GrantedPermission_location | Access_Background_Location, |
| | Access_Fine_Location, |
| | Access_Coarse_Location |
| GrantedPermission_media | Read_Media_Visual_User_Selected, |
| | Read_Media_Video, |
| | Read_Media_Location, |
| | Read_Media_Images |
| GrantedPermission_storage_{—} | Write_External_Storage, |
| and_phone state | Read_External_Storage, |
| | Read_Phone_Numbers, |
| | Read_Phone_State |
| GrantedPermission_contacts_{—} | Send_Sms, Receive_Sms, Write_{—} |
| and_sms | Contacts, Read_Contacts |
| GrantedPermission_camera_{—} | Camera, Activity_{—} |
| and_mic | Recognition, Record_Audio |

For example, the data indicating the permission granted to the application may be converted into numerical data according to Equation 2 below.

$$Granted Permission score = \sum {S}_{i} * {G}_{j} \qquad Equation 2$$

The Granted Permission score indicates a value obtained by converting the permissions granted to the application into numerical data. Sᵢ indicates a score of a group in which the permissions granted to the application are included. Gⱼ indicates the number of permissions included in the corresponding group. In an example, the permissions granted to applications may include a first permission, a second permission, and a third permission. The first permission and the second permission may be included in a first group, and the third permission may be included in a second group. The value obtained by converting the permissions granted to the application into the numerical data may be a score S₁ of the first group*the number (e.g., 2) of permissions included in the first group+a score S₂ of the second group*the number (e.g., 1) of permissions included in the second group.

Hereinafter, operations 602 to 604 may be performed periodically. The electronic device 101 may periodically perform the operations 602 to 604 based on datasets obtained in the active state, the idle state, and/or the sleep state. In an example, the datasets may be obtained in real-time. In an example, the electronic device 101 may perform the operations 602 to 604 based on a designated period (e.g., a day or a week). In an example, the designated period may be designated by the user or may be pre-designated.

In the operation 602, the electronic device 101 according to an embodiment may identify (or generate) a privacy score and a threshold score for respective data included in the datasets. A trained artificial intelligence model may be used to identify (or generate) the privacy score and the threshold score. In an example, the trained artificial intelligence model may be a variational auto-encoder (VAE). However, this is only an example, and the disclosure is not limited thereto. For example, the trained artificial intelligence model may be a large language model (LLM), a conditional VAE, a long short-term memory (LSTM)-based artificial intelligence model, a support vector machine (SVM)-based artificial intelligence model, a transformer-based artificial intelligence model, or a combination thereof (e.g., an ensemble method). In an example, the trained artificial intelligence model may be the LLM. In a case that the LLM is used to identify (or generate) the privacy score and the threshold score, the electronic device 101 may include only the LLM for operations in accordance with the disclosure. The electronic device 101 may lighten an on-device model and increase efficiency of fine-tuning for the LLM by using only the LLM.

In an embodiment, the electronic device 101 may be based on a multi-stream method to enable more accurate prediction by separately learning a categorical dataset and a numerical dataset. In an example, since the first type (e.g., binary) of dataset may be classified into both the categorical dataset and the numerical dataset, the first type (e.g., binary) of dataset may be provided as an input to an artificial intelligence model trained through a first stream and/or a second stream. In an example, the second type (e.g., numerical) of dataset may be provided as an input to an artificial intelligence model trained through the first stream. In an example, the third type (e.g., categorical) of dataset may be provided as an input to an artificial intelligence model trained through the second stream. However, this is only an example for description, and the disclosure is not limited thereto.

In an embodiment, the electronic device 101 may identify a mean and a standard deviation for respective data based on the datasets. In an example, an encoder of a VAE may be used to identify the mean and the standard deviation. The electronic device 101 may identify (or generate) a privacy score of the corresponding data based on the mean and the standard deviation. The privacy score, which is a standard value (or a standard score, a Z-score, a Z-value) of the corresponding data, may be identified (or generated) according to the above-described Equation 1. For example, the privacy score is a numerical value indicating a degree of normality or abnormality of an event associated with the data. In an example, the privacy score may indicate a privacy threat level (or the degree of abnormality of the event) of the corresponding data. The privacy score may be proportional to the privacy threat level of the corresponding data. For example, the privacy threat level may indicate a degree of sensitivity of information accessed by permission usage of the application and/or a possibility of leakage of information accessed by the permission usage of the application. In an example, as the privacy threat level increases, the degree of sensitivity of information and/or the possibility of information leakage may also increase.

In an embodiment, the electronic device 101 may identify (or generate) the privacy score of the corresponding data based on the mean and the standard deviation for the respective data included in the datasets, and a correlation value between the permission used by the application and another permission. The correlation value may indicate a correlation between a plurality of permissions (e.g., a camera permission, a microphone permission, a location permission, an access permission to a nearby device, a short message service (SMS) permission, a contact permission, a music/audio permission, a call log permission, a calendar permission, a photo/video permission). In an example, the correlation value between a plurality of permissions may be pre-designated. In an example, a correlation value between the camera permission and the photo/video permission may be relatively high. Therefore, in a case that an application uses both the camera permission and the photo/video permission, which have a high correlation, a possibility of a privacy threat situation occurring may be relatively low. In an example, a correlation value between the contact permission and the music/audio permission may be relatively low. Therefore, in a case that an application uses both the contact permission and the music/audio permission, which have a low correlation, a possibility of a privacy threat situation occurring may be relatively high. However, this is only an example for description, and the disclosure is not limited thereto.

In an embodiment, the electronic device 101 may identify (or generate) a threshold score for the respective data included in the datasets based on the mean of the corresponding data, the standard deviation of the corresponding data, and/or sampled noise. For example, the electronic device 101 may generate a latent vector based on the mean of the data, the standard deviation of the data, and/or the sampled noise. For example, the electronic device 101 may generate a threshold score for the data based on the latent vector and a loss function. For example, based on a type of data, a different loss function may be used to generate the threshold score. In an example, in a case that the data is included in the first type (e.g., binary), a first loss function (e.g., binary cross entropy) may be used to generate the threshold score for the data. In an example, in a case that the data is included in the second type (e.g., numerical), a second loss function may be used to generate the threshold score for the data. In an example, in a case that the data is included in the third type (e.g., categorical), a third loss function (e.g., categorical cross entropy) may be used to generate the threshold score for the data. In an example, the threshold score may be referred to as a feature wise threshold. However, this is only an example and the disclosure is not limited thereto. In an example, the threshold score may be generated according to Equation 3 below.

$${Feature}_{wis {e}_{t h r e s h o l d}} = [ {Binary}_{Cros {s}_{E n t r o py ( {Binary}_{o u t p u t s} )}} , {Categorical}_{Cros {s}_{E n t r o py ( {Categorical}_{o u t p u t s} )}} ] \qquad Equation 3$$

In Equation 3, Feature_wise_threhold may indicate the threshold score of the data. In an example, the threshold score may have a value between 0 and 1. Binary_Cross_Entropy may indicate a loss function (e.g., binary cross entropy) used to generate the threshold score for data included in the first type (e.g., binary). Binary_outputs may indicate the data of the first type (e.g., binary). Categorical_Cross_Entropy may indicate a loss function (e.g., categorical cross entropy) used to generate the threshold score for data included in the third type (e.g., categorical). Categorical_outputs may indicate the data of the third type (e.g., categorical).

For example, the threshold score may be used as a reference value for determining a degree of normality or abnormality of the event associated with the data. For example, in accordance with an identification that the privacy score of the data exceeds the threshold score, the electronic device 101 may identify that the event associated with the corresponding data is abnormal. In an example, in a case that a privacy score for data indicating the number of executions of the application for use of the camera permission of the application exceeds the corresponding threshold score, the electronic device 101 may identify that the number executions of the application for the use of the camera permission is abnormal. For example, in accordance with an identification that the privacy score of the data is less than the threshold score, the electronic device 101 may identify that an event associated with the corresponding data is normal. In an example, in a case that the privacy score for data indicating power usage for the use of the camera permission of the application is less than the corresponding threshold score, the electronic device 101 may identify that the power usage for the use of the camera permission is normal.

For example, the threshold score may be used to identify input data for generating a prompt. For example, data having a privacy score exceeding the threshold score may be identified as the input data for generating the prompt. In an example, in a case that a privacy score for data indicating the number of executions of the application for use of the camera permission of the application exceeds the corresponding threshold score, the data indicating the number of executions of the application may be identified as the input data for generating the prompt. For example, data having a privacy score less than or equal to the threshold score may not be identified as the input data for generating the prompt. In an example, in a case that a privacy score for data indicating power usage for the use of the camera permission of the application is less than the corresponding threshold score, the data indicating power usage may not be identified as the input data for generating the prompt.

In operation 603, the electronic device 101 according to an embodiment may obtain (or generate) the prompt by using at least one data having a privacy score exceeding the threshold score among the datasets.

In an embodiment, the electronic device 101 may identify at least one data having a privacy score exceeding the threshold score among the datasets. For example, the electronic device 101 may identify one or more first data having a privacy score exceeding a first threshold score among the first type of dataset. For example, the electronic device 101 may identify one or more second data having a privacy score exceeding a second threshold score among the second type of dataset. For example, the electronic device 101 may identify one or more third data having a privacy score exceeding a third threshold score among the third type of dataset.

In an embodiment, the electronic device 101 may generate a prompt based on the one or more first data, one or more privacy scores of the one or more first data, the one or more second data, privacy scores of the one or more second data, the one or more third data, and privacy scores of the one or more third data. In a non-limiting example, to generate the prompt, an output of an LLM using the datasets as input data and/or external data obtained using retrieval augmented generation (RAG) may further be used. By using the output of the LLM using the datasets as the input data, content (or suggestion) for a privacy situation may further include information indicating a terminal status (e.g., a battery state, a security state). By using the external data obtained using RAG, the LLM may be enabled to consider additional information when generating the content.

In an example, a dataset and a prompt generated in accordance with the dataset may be as shown in Table 3 and Table 4 below.

TABLE 3

| | | | Usage | | Permission |
|---|---|---|---|---|---|
| Time- | | Permis- | frequency of | Usage | access |
| stamp | uid | sion 1 | last week | frequency | duration |
| 06-23 | 16467 | Camera | 10 | 500 | 2 minutes |
| 21:59:00 | | | | | |

In an example of Table 3, a privacy score (e.g., 0.8) for first data (e.g., usage frequency) for the camera permission may exceed a threshold score (e.g., 0.5) for the first data, and a privacy score (e.g., 0.1) for second data (e.g., permission access duration) may be less than a threshold score (e.g., 0.4) for the second data. The first data having the privacy score exceeding the corresponding threshold score may be used to generate a prompt for the camera permission. The second data having the privacy score less than the corresponding threshold score may not be used to generate a prompt. In an example, the prompt generated based on the first data may be as shown in Table 4 below. However, this is only an example for description, and the disclosure is not limited thereto.

TABLE 4
The usage frequency of the camera permission is abnormal. The
application used the camera permission 10 times last week. The
application used the camera permission 500 times today. The privacy
score for the camera permission usage of the application is 0.8. The
privacy score may have a value between 0 and 1. The higher the privacy
score, the greater the risk of personal information leakage. Please
generate a recommendation for a privacy threat based on the information.

In operation 604, the electronic device 101 according to an embodiment may display content generated based on the prompt through a display 230. The content may be for guiding the user to obtain (or display) a recommendation for a privacy threat.

In an embodiment, the electronic device 101 may generate content based on the prompt by using an on-device language model (e.g., LLM). As the on-device language model is used, a risk of user data being leaked to the outside may be reduced. The language model may be a fine-tuned model using low-rank adaptation (LoRA).

In an embodiment, the electronic device 101 may transmit the prompt to an external server (e.g., a server 900 of FIG. 9). The electronic device 101 may obtain (or receive) content generated in accordance with the prompt from the external server. In a case of using the external server, the electronic device 101 may be based on federated analysis (FA), and the external server may be based on federated learning (FL). By using a high-performance artificial intelligence model of the external server, accuracy of prediction may be improved, and at the same time, since raw data is used only in the electronic device 101, security may be enhanced.

In an embodiment, the electronic device 101 may display the generated content (or privacy context information) through the display 230. In an example, in a case that a plurality of contents are generated, the contents may be displayed based on priority. In an example, the priority may be shown in Table 5 below.

TABLE 5

| Priority | 1 | 2 |
|---|---|---|
| Detail | Designated permission (e.g., | Privacy score |
| | a camera permission, a | |
| | microphone permission, or a | |
| | location permission) | |

Referring to Table 5, in a case that a plurality of contents are generated, content related to a designated permission (e.g., a camera permission, a microphone permission, or a location permission) may be preferentially displayed. In a case that the plurality of contents have the same priority (e.g., in a case that content for the camera permission and content for the microphone permission are generated), content having a higher privacy score may be preferentially displayed. For example, the content may include a message for guiding the user to obtain the recommendation for the privacy threat, an object for dismissing the content, and/or an object for displaying a setting screen for the corresponding permission of an application. For example, the electronic device 101 may obtain user input (e.g., touch input) for the object for dismissing the content. For example, in response to obtaining the user input for a UI for dismissing the content, the electronic device 101 may add the corresponding application to an allow list. After adding the application to the allow list, the electronic device 101 may refrain from generating content indicating a privacy situation for the application. The electronic device 101 may prevent privacy context information not requested by the user from being displayed through the display 230 by refraining from generating the content for an application included in the allow list. For example, the electronic device 101 may not display the content in response to obtaining the user input for the UI for dismissing the content. For example, the electronic device 101 may display a screen (e.g., a screen 1120 of FIG. 11) for activating/deactivating settings (e.g., allow only while using the app, always check, and/or do not allow) for a permission of the application based on obtaining user input for the object for displaying a setting screen for the corresponding permission of the application.

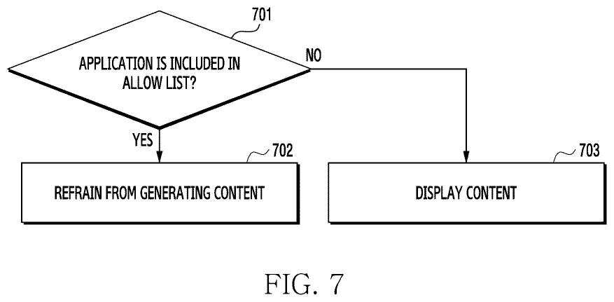

FIG. 7 is a flowchart indicating operations of an electronic device for refraining from displaying content for an application included in an allow list according to an embodiment of the disclosure. The operations of FIG. 7 may be performed by the electronic device 101 of FIGS. 1 and 2. For example, at least some of the operations may be controlled by a processor 210 of the electronic device 101. Hereinafter, each operation may be performed sequentially, but is not necessarily performed sequentially. For example, an order of the operations may be changed. For example, at least two operations may be performed in parallel. The operations illustrated in FIG. 7 may be performed after one of the operations illustrated in FIG. 6, or may be performed in parallel with some of the operations.

Referring to FIG. 7, in operation 701, the electronic device 101 according to an embodiment may identify whether an application using a permission is included in the allow list. The allow list may include applications set to refrain from displaying content indicating a privacy situation through a display 230. For example, the allow list may include a preload application and/or an application set by a user.

In operation 702, the electronic device 101 according to an embodiment may refrain from generating content in accordance with an identification that the application is included in the allow list. The electronic device 101 may prevent privacy context information not requested by the user from being displayed through the display 230 by refraining from generating content for the application included in the allow list.

In operation 703, the electronic device 101 according to an embodiment may display, through the display 230, content generated based on a prompt in accordance with an identification that the application using the permission is not included in the allow list. At least some of the operations described in FIG. 6 may be substantially identically applied to the description of the operation 703.

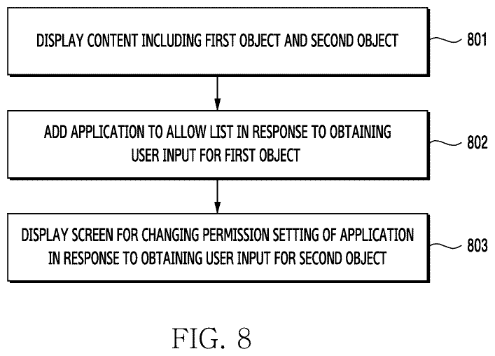

FIG. 8 is a flowchart indicating operations of an electronic device for setting a permission for an application based on user feedback according to an embodiment of the disclosure. The operations of FIG. 8 may be performed by the electronic device 101 of FIGS. 1 and 2. For example, at least some of the operations may be controlled by a processor 210 of the electronic device 101. Hereinafter, each operation may be performed sequentially, but is not necessarily performed sequentially. For example, an order of each operation may be changed. For example, at least two operations may be performed in parallel. The operations of FIG. 8 may be performed after or in parallel with the operation 604 of FIG. 6.

Referring to FIG. 8, in operation 801, the electronic device 101 according to an embodiment may display content including a first object and a second object through a display 230. For example, the first object may be an object for obtaining user input for dismissing the content displayed on the display 230. For example, the second object may be an object for obtaining user input for displaying a screen for changing a setting (e.g., allow only while using the app, always check, or do not allow) for a permission of an application. In the operation 801, the description of the operations of the electronic device 101 of FIG. 6 may be substantially identically applied to the description of operations of the electronic device 101 displaying the content through the display 230.

In operation 802, the electronic device 101 according to an embodiment may add an application to an allow list in response to obtaining user input for the first object. After adding the application to the allow list, the electronic device 101 may refrain from generating content indicating a privacy situation for the application. The electronic device 101 may prevent privacy context information not requested by a user from being displayed through the display 230 by refraining from generating content for the application included in the allow list.

In operation 803, the electronic device 101 according to an embodiment may display a screen (e.g., a screen 1120 of FIG. 11) for changing a permission setting of the application in response to obtaining user input for the second object. The user may understand a privacy threat situation that occurred in the electronic device 101 based on the content displayed through the display 230. The user may prevent the application from using (or accessing) the corresponding permission based on the understanding of the privacy threat situation. Sensitive information of the user may be prevented from leaking to the outside by blocking access of the application to the corresponding permission.

FIG. 9 illustrates signaling between an electronic device and a server for providing content for a privacy situation according to an embodiment of the disclosure. Operations of FIG. 9 may be performed by the electronic device 101 of FIGS. 1 and 2. For example, at least some of the operations may be controlled by a processor 210 of the electronic device 101. Hereinafter, each operation may be performed sequentially, but is not necessarily performed sequentially. For example, an order of each operation may be changed. For example, at least two operations may be performed in parallel. Hereinafter, ‘data’ included in datasets means an independent type of data. The ‘data’ may be referred to as a data instance, a data item, a data element, a data sample, or another term having an equivalent technical meaning.

Referring to FIG. 9, in operation 901, the electronic device 101 according to an embodiment may obtain datasets related to use of a permission of an application. For example, the datasets may mean a set of data collected (or obtained) while the application uses the permission. In an example, the permission may be one of a camera permission, a microphone permission, a location permission, an access permission to a nearby device, a short message service (SMS) permission, a contact permission, a music/audio permission, a call log permission, a calendar permission, and a photo/video permission. However, this is only an example, and the disclosure is not limited thereto. The permission may be another permission other than the examples described above.

In an embodiment, the datasets may include data indicating a source (or an install path) of the application, data indicating the number of executions of the application, data indicating usage time of the application, data indicating a category of the application, data indicating a trust level of the application, data indicating a permission granted to the application, data indicating whether the application is executed in a foreground (or a background), data indicating power usage, data indicating network usage, data indicating permission access duration of the application, data indicating central processing unit (CPU) usage time, data indicating whether the permission of the application is granted by a request of the application or by a user, and/or data indicating whether user input is obtained. The above-described example is merely, and the disclosure is not limited thereto. The datasets may further include other data other than the above-described examples.

In an embodiment, the datasets may include a first type (e.g., binary) of dataset, a second type (e.g., numerical) of dataset, and/or a third type (e.g., categorical) of dataset. In an example, the first type of dataset may include data indicating whether the application is executed in the foreground (or background), data indicating whether the permission of the application is granted by a request of the application or by the user, and/or data indicating whether user input is obtained. In an example, the second type of dataset may include data indicating the number of executions of the application, data indicating usage time of the application, data indicating the permission granted to the application, data indicating power usage, data indicating network usage, data indicating permission access duration of the application, and/or data indicating CPU usage time. In an example, the third type of dataset may include category data of the application, data for a trust level of the application, and/or data for a source (or an install path) of the application. However, this is only an example, and the disclosure is not limited thereto. The above-described data may be classified into one of the first type of dataset, the second type of dataset, or the third type of dataset in accordance with a method of representing the data.

In an embodiment, the second type (e.g., numerical) of dataset may include data indicating the permission granted to the application. The electronic device 101 may perform a conversion to convert the data indicating the permission granted to the application into a numerical form. In an example, the electronic device 101 may convert the data indicating the permission granted to the application into the numerical form based on the description according to Table 2 and Equation 2. The data indicating the permission granted to the application may be classified into the second type (e.g., numerical) of dataset based on the conversion.

In operation 902, the electronic device 101 according to an embodiment may generate a prompt.

In an embodiment, the electronic device 101 may identify (or generate) a privacy score and a threshold score for respective data included in the datasets. A trained artificial intelligence model may be used to identify (or generate) the privacy score and the threshold score. In an example, the trained artificial intelligence model may be a variational auto-encoder (VAE). However, this is only an example, and the disclosure is not limited thereto. For example, the trained artificial intelligence model may be a large language model (LLM), a conditional VAE, a long short-term memory (LSTM)-based artificial intelligence model, a support vector machine (SVM)-based artificial intelligence model, a transformer-based artificial intelligence model, or a combination thereof (e.g., an ensemble method). In an example, the trained artificial intelligence model may be the LLM. In a case that the LLM is used to identify (or generate) the privacy score and the threshold score, the electronic device 101 may include only the LLM for operations in accordance with the disclosure. The electronic device 101 may lighten an on-device model and increase efficiency of fine-tuning for the LLM by using only the LLM.

In an embodiment, the electronic device 101 may be based on a multi-stream method to enable more accurate prediction by separately learning a categorical dataset and a numerical dataset. In an example, since the first type (e.g., binary) of dataset may be classified into both the categorical dataset and the numerical dataset, the first type (e.g., binary) of dataset may be provided as an input to an artificial intelligence model trained through a first stream and/or a second stream. In an example, the second type (e.g., numerical) of dataset may be provided as an input to an artificial intelligence model trained through the first stream. In an example, the third type (e.g., categorical) of dataset may be provided as an input to an artificial intelligence model trained through the second stream. However, this is only an example for description, and the disclosure is not limited thereto.

In an embodiment, the electronic device 101 may identify a mean and a standard deviation for respective data based on the datasets. In an example, an encoder of a VAE may be used to identify the mean and the standard deviation. The electronic device 101 may identify (or generate) a privacy score of the corresponding data based on the mean and the standard deviation. The privacy score, which is a standard value (or a standard score, a Z-score, a Z-value) of the corresponding data, may be identified (or generated) according to the above-described Equation 1. For example, the privacy score is a numerical value indicating a degree of normality or abnormality of an event associated with the data. For example, the privacy score may indicate a privacy threat level of the corresponding data. The privacy score may be proportional to the privacy threat level of the corresponding data. For example, the privacy threat level may indicate a degree of sensitivity of information accessed by permission usage of the application and/or a possibility of leakage of information accessed by the permission usage of the application. In an example, as the privacy threat level increases, the degree of sensitivity of information and/or the possibility of information leakage may also increase.

In an embodiment, the electronic device 101 may identify (or generate) the privacy score of the corresponding data based on the mean and the standard deviation for the respective data included in the datasets, and a correlation value between the permission used by the application and another permission. The correlation value may indicate a correlation between a plurality of permissions (e.g., a camera permission, a microphone permission, a location permission, an access permission to a nearby device, a short message service (SMS) permission, a contact permission, a music/audio permission, a call log permission, a calendar permission, a photo/video permission). In an example, the correlation value between a plurality of permissions may be pre-designated. In an example, a correlation value between the camera permission and the photo/video permission may be relatively high. Therefore, in a case that an application uses both the camera permission and the photo/video permission, which have a high correlation, a possibility of a privacy threat situation occurring may be relatively low. In an example, a correlation value between the contact permission and the music/audio permission may be relatively low. Therefore, in a case that an application uses both the contact permission and the music/audio permission, which have a low correlation, a possibility of a privacy threat situation occurring may be relatively high. However, this is only an example for description, and the disclosure is not limited thereto.

In an embodiment, the electronic device 101 may identify (or generate) the threshold score for the respective data included in the datasets based on the mean and the standard deviation of the corresponding data. For example, the threshold score may be used to identify input data for generating a prompt. In an example, data having a privacy score exceeding the threshold score may be identified as the input data for generating the prompt. In another example, data having a privacy score below the threshold score may not be identified as the input data for generating the prompt. For example, a different loss function may be used to obtain the threshold score based on a type of the datasets. In an example, a first loss function (e.g., binary cross entropy) may be used to identify (or obtain) a first threshold score for respective data included in the first type (e.g., binary) of dataset. In an example, a second loss function may be used to identify (or obtain) a second threshold score for respective data included in the second type (e.g., numerical) of dataset. In an example, a third loss function (e.g., categorical cross entropy) may be used to identify (or obtain) a third threshold score for respective data included in the third type (e.g., categorical) of dataset.

In an embodiment, the electronic device 101 may identify at least one data having a privacy score exceeding the threshold score among the datasets. For example, the electronic device 101 may identify one or more first data having a privacy score exceeding the first threshold score among the first type of dataset. For example, the electronic device 101 may identify one or more second data having a privacy score exceeding the second threshold score among the second type of dataset. For example, the electronic device 101 may identify one or more third data having a privacy score exceeding the third threshold score among the third type of dataset.

In an embodiment, the electronic device 101 may generate a prompt based on the one or more first data, one or more privacy scores of the one or more first data, the one or more second data, privacy scores of the one or more second data, the one or more third data, and privacy scores of one or more third data. In a non-limiting example, to generate the prompt, an output of an LLM using the datasets as input data and/or external data obtained using retrieval augmented generation (RAG) may further be used. By using the output of the LLM using the datasets as the input data, content (or suggestion) for a privacy situation may further include information indicating a state of a terminal (e.g., battery state, security state). By using the external data obtained using RAG, the LLM may be enabled to consider additional information when generating the content.

In operation 903, the electronic device 101 according to an embodiment may transmit the prompt to a server 900 through communication circuitry 220.

In operation 904, the electronic device 101 according to an embodiment may obtain (or receive) content (or privacy context information) from the server 900 through the communication circuitry 220 for guiding the user regarding a privacy threat. For example, the electronic device 101 may be based on federated analysis (FA), and an external server may be based on federated learning (FL). By using a high-performance artificial intelligence model of the server 900, accuracy of prediction may be improved, and at the same time, since raw data is used only in the electronic device 101, security may be enhanced.

In an embodiment, the electronic device 101 may display the generated content through a display 230. The content may include a message for guiding the user to obtain the recommendation for the privacy threat, an object for dismissing the content, and/or an object for displaying a setting screen for the corresponding permission of an application. For example, the electronic device 101 may obtain user input (e.g., touch input) for the object for dismissing the content. In response to obtaining the user input for the object for dismissing the content, the electronic device 101 may add the corresponding application to an allow list. After adding the application to the allow list, the electronic device 101 may refrain from generating content indicating a privacy situation for the application. The electronic device 101 may prevent privacy context information not requested by the user from being displayed through the display 230 by refraining from generating the content for an application included in the allow list. For example, the electronic device 101 may display a screen (e.g., a screen 1120 of FIG. 11) for activating/deactivating settings (e.g., allow only while using the app, always check, and/or do not allow) for a permission of the application based on obtaining user input for a UI for displaying a setting screen for the corresponding permission of the application.

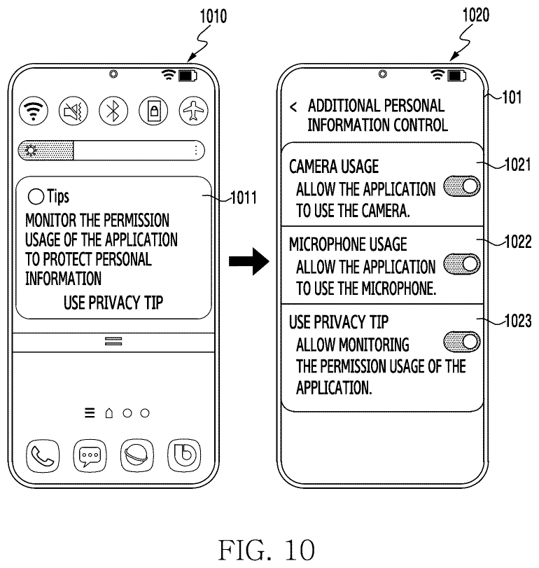

FIG. 10 illustrates an example of screens for setting a function to provide content for permission usage of an application according to an embodiment of the disclosure.

Referring to FIG. 10, in a screen 1010, an electronic device 101 may display content 1011 for setting a function (e.g., privacy tip) for providing summary information (or privacy context information or content) on the permission usage of the application to a user through a display 230. The content 1011 may include an image of the corresponding function and/or text for describing the corresponding function. In an example, the text for describing the function for providing the summary information on the permission usage of the application may be ‘Monitor the permission usage of the application to protect personal information’. However, this is only an example for description, and the disclosure is not limited thereto. For example, the image and/or the text of the function for providing the summary information on the permission usage of the application may be different from what is illustrated in FIG. 10. The electronic device 101 may obtain user input (e.g., touch input) on the content 1011 displayed through the display 230. In response to obtaining the user input on the content 1011, the electronic device 101 may change a screen displayed through the display 230 from the screen 1010 to a screen 1020.

Referring to FIG. 10, in the screen 1020, the electronic device 101 may display content for activating (or deactivating) functions related to the permission usage of the application through the display 230. For example, the screen 1020 may include content 1021 for use of a camera permission, content 1022 for use of a microphone permission, and content 1023 for a function to provide summary information on permission usage of applications. The content 1023 may include text for describing the function for providing the summary information on the permission usage of the application and/or an object for obtaining user input for activating (or deactivating) the corresponding function. In an example, the text for describing the function for providing the summary information on the permission usage of the application may be ‘Allow monitoring the permission usage of the application’. However, this is only an example for description, and the disclosure is not limited thereto. For example, the text for describing the function for providing the summary information on the permission usage of the application may be different from what is illustrated in FIG. 10.

FIG. 11 illustrates an example of screens for revoking a permission of an application according to an embodiment of the disclosure. A screen illustrated in FIG. 11 may mean a screen displaying content for guiding a user to obtain (or display) a recommendation for a privacy threat, in accordance with the operations described in FIG. 6. For example, the content may be for providing the user with a notification for the recommendation.

Referring to FIG. 11, in a screen 1110, an electronic device 101 may display, through a display 230, text 1111 for guiding the user to obtain the recommendation for a privacy threat situation caused by permission usage of the application, an object 1112 for obtaining user input, an object 1113 for obtaining user input, text 1114 for describing the permission, content 1115 for a camera permission, content 1116 for a microphone permission, content 1117 for a location permission, content 1118 for a call log permission, and content 1119 for a contact permission. For example, the text for guiding the user regarding the permission usage of the application may be text generated based on a large language model (LLM) using a prompt. The text may indicate a privacy situation. In an example, the text may be ‘Application A accessed the camera permission 229 times over the past 8 days while the terminal was locked. Application A is dangerous because its source is unknown’. However, this is only an example for description, and the disclosure is not limited thereto. For example, the object 1112 may be an object for obtaining user input to dismiss content (e.g., the text 1111) displayed for guiding the user regarding the privacy threat. In a case of obtaining user input (e.g., touch input) for the object 1112, the electronic device 101 may include an application (e.g., the application A) using a permission (e.g., the camera permission) in an allow list. For example, the object 1113 may be an object for obtaining user input to display a screen for changing a permission setting for an application for the privacy threat. In a case of obtaining user input (e.g., touch input) for the object 1113, the electronic device 101 may change a screen displayed through the display 230 from the screen 1110 to a screen 1120. For example, the content 1115 may include an image for the camera permission, text indicating the camera permission, an image indicating applications using the camera permission, and/or an image indicating that a privacy threat has occurred with the camera permission. For example, the content 1116 may include an image for the microphone permission, text indicating the microphone permission, and/or an image indicating applications using the microphone permission. For example, the content 1117 may include an image for the location permission, text indicating the location permission, and/or an image indicating applications using the location permission. Contents for permissions (e.g., the camera permission, the microphone permission, the location permission) accessible to sensitive information of the user may be displayed separately from contents for other permissions, in a portion of the screen displayed through the display 230.

For example, the content 1118 may include an image for the call log permission, text indicating the call log permission, and/or an image indicating applications using the call log permission. For example, the content 1119 may include an image for the contact permission, text indicating the contact permission, and/or an image indicating applications using the contact permission. The content displayed on the screen 1110 of FIG. 11 is only an example for description. The screen 1110 of FIG. 11 may be implemented in various forms including information displayed on the screen 1110.

Referring to FIG. 11, the screen 1120 is a screen for changing a setting for the permission (e.g., the camera permission) of the application (e.g., the application A). The electronic device 101 may display the screen 1120 in response to obtaining the user input for the object 1113 on the screen 1110. The electronic device 101 may include an object 1121 for obtaining user input for activating a first setting (e.g., allow only while using the app) for the permission of the application, an object 1122 for obtaining user input for activating a second setting (e.g., always check) for the permission of the application, and an object 1123 for obtaining user input for activating a third setting (e.g., do not allow) for the permission of the application.

The electronic device 101 may display summary information (e.g., the text 1111) of the privacy situation, other than simply listing information on the privacy situation on the screen 1110. The user may identify (or understand) a privacy threat situation that has occurred in the electronic device 101 based on the summary information (e.g., the text 1111) displayed on the screen 1110. The user may provide touch input to the object 1113 to revoke the permission (e.g., the camera permission) from the application (e.g., the application A) in response to identifying the privacy threat situation. The electronic device 101 may display the screen 1120 for revoking the corresponding permission (e.g., the camera permission) from the application (e.g., the application A) based on the touch input to the object 1113. The user may prevent the corresponding application (e.g., the application A) from using (or accessing) the corresponding permission (e.g., the camera permission) by providing the touch input to the object 1123 based on the understanding of the privacy situation. Sensitive information of the user may be prevented from leaking to the outside by blocking access of the application to the corresponding permission.

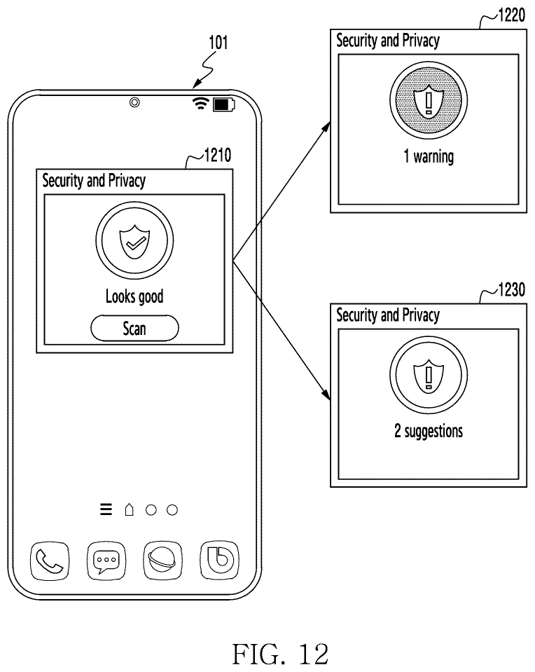

FIG. 12 illustrates an example of screens displaying a level for a privacy situation according to an embodiment of the disclosure. FIG. 12 describes a screen providing the level of the privacy situation in a form of a widget.

Referring to FIG. 12, an electronic device 101 may display contents indicating the level for the privacy threat situation through a display 230. For example, the contents may include content 1210, content 1220, and content 1230. The content 1210 may include an image and/or text indicating that a privacy threat situation has not occurred. The content 1220 may include an image and/or text indicating that the privacy threat situation has occurred. The content 1230 may include an image and/or text indicating that there is a suggestion for the privacy threat situation.

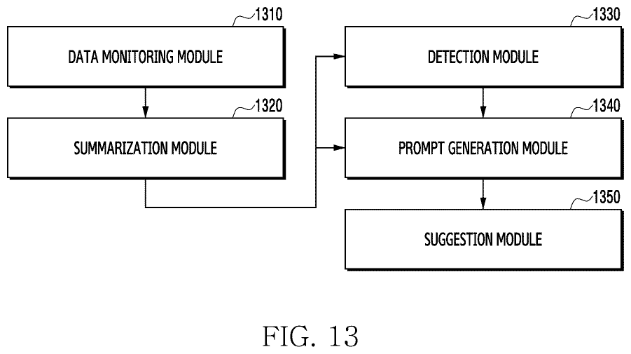

FIG. 13 is a block diagram for describing operations of an electronic device for providing a user with a suggestion to solve a privacy threat according to an embodiment of the disclosure. Hereinafter, a term ‘module’ means a unit implemented as hardware or software to perform a designated function. The ‘module’ may be referred to as logic, a logic block, a component, circuitry, or another term having an equivalent technical/functional meaning.

Referring to FIG. 13, an electronic device 101 may include a data monitoring module 1310, a summarization module 1320, a detection module 1330, a prompt generation module 1340, and/or a suggestion module 1350. Components of the electronic device 101 exemplified in FIG. 13 may be implemented as a portion of the hardware components (e.g., the processor 210, the communication circuitry 220, the display 230, the memory 240, and/or the artificial intelligence module 250) exemplified in FIG. 2.

In an embodiment, the electronic device 101 may include the data monitoring module 1310. The data monitoring module 1310 may collect (or obtain) datasets. The datasets may include data collected (or obtained) while an application uses a permission. Hereinafter, ‘data’ included in the datasets means an independent type of data. The ‘data’ may be referred to as a data instance, a data item, a data element, a data sample, or another term having an equivalent technical/functional meaning.

In an embodiment, datasets 501 may include a plurality of types of data. A first type (e.g., a critical permission) of data may include data indicating a permission granted to an application among permissions (e.g., a nearby device permission, a microphone permission, a photo and video permission, a body sensor permission, a physical activity permission, a notification permission, a contact permission, a location permission, a music and audio permission, a phone permission, a camera permission, a calendar permission, a call log permission, a file permission, and a short message service (SMS) permission). A second type (e.g., a permission status) of data may include data indicating whether the permission(s) granted to the application is granted by a request of the application or by a user. A third type (e.g., an application) of data may include data indicating a source (or an install path) of the application, data indicating the number of executions of the application, data indicating usage time of the application, data indicating a category of the application, data indicating a trust level of the application, data indicating whether the application is executed in a foreground (or a background), and/or data indicating permission access duration of the application. A fourth type (e.g., user context) of data may include data indicating whether user input is obtained. A fifth type (e.g., a device status) of data may include data indicating central processing unit (CPU) usage time, data indicating power usage, and/or data indicating network usage. The datasets 501 may include at least a portion of the above-described data. In addition, the above-described data is only an example, and the disclosure is not limited thereto. The datasets 501 may further include data other than the above-described examples. In a non-limiting example, the datasets 501 may further include data (e.g., sensor data of a watch, microphone data of a remote controller, and camera data of a robot vacuum cleaner) of a wearable device connected to the electronic device 101.

In an embodiment, the datasets 501 may include a first type (e.g., binary) of dataset, a second type (e.g., numerical) of dataset, and/or a third type (e.g., categorical) of dataset. In an example, the first type of dataset may include data indicating whether the application is executed in the foreground (or background), data indicating whether a permission of the application is granted by a request of the application or by the user, and/or data indicating whether user input is obtained. In an example, the second type of dataset may include data indicating the number of executions of the application, data indicating usage time of the application, data indicating the permission granted to the application, data indicating power usage, data indicating network usage, data indicating permission access duration of the application, and/or data indicating CPU usage time. In an example, the third type of dataset may include category data of the application, data for a trust level of the application, and/or data for a source (or an install path) of the application. However, this is only an example, and the disclosure is not limited thereto. The above-described data may be classified into one of the first type of dataset, the second type of dataset, or the third type of dataset in accordance with a method of representing the data.

In an embodiment, the data monitoring module 1310 may perform preprocessing on the collected datasets. For example, the preprocessing may include missing value processing for biased data, outlier processing, data normalization, and/or data type conversion. For example, the data monitoring module 1310 may convert categorical data into numerical data. In an example, the data monitoring module 1310 may convert data indicating the permission granted to the application into the numerical data in accordance with the above-described description of Table 2 and Equation 2. The data indicating the permission granted to the application may be classified into the second type (e.g., numerical) of dataset by being converted into the numerical data.

In an embodiment, the data monitoring module 1310 may provide the preprocessed datasets to the summarization module 1320.

In an embodiment, the electronic device 101 may include the summarization module 1320. The summarization module 1320 may include a large language model (LLM). For example, the LLM may use the datasets as input data. The LLM may output data indicating one or more datasets among the datasets and a terminal status (e.g., a security state or a battery state). The summarization module 1320 may provide the output of the LLM to the detection module 1330 and the prompt generation module 1340.

In an embodiment, the electronic device 101 may include the detection module 1330. The detection module 1330 may include an encoder for outputting a mean and a standard deviation for respective data included in one or more datasets that are the output of the LLM, and a decoder for outputting a threshold score for the respective data included in the one or more datasets based on the output of the encoder. In an example, a trained artificial intelligence model used in the detection module 1330 may be a variational auto-encoder (VAE) including the encoder and the decoder. However, this is only an example, and the disclosure is not limited thereto. For example, the trained artificial intelligence model used in the detection module 1330 may be a large language model (LLM), a conditional VAE, a long short-term memory (LSTM)-based artificial intelligence model, a support vector machine (SVM)-based artificial intelligence model, a transformer-based artificial intelligence model, or a combination thereof (e.g., an ensemble method). In an example, the trained artificial intelligence model may be the LLM. The electronic device 101 may lighten an on-device model and increase efficiency of fine-tuning for the LLM by using only the LLM in operations in accordance with the disclosure.

In an embodiment, the detection module 1330 may be based on a multi-stream method to enable more accurate prediction by separately learning a categorical dataset and a numerical dataset. For example, the one or more datasets may include the first type (e.g., binary) of dataset, the second type (e.g., numerical) of dataset, and/or the third type (e.g., categorical) of dataset. In an example, since the first type (e.g., binary) of dataset may be classified into both the categorical dataset and the numerical dataset, the first type (e.g., binary) of dataset may be provided as an input to the encoder through a first stream and/or a second stream. In an example, the second type (e.g., numerical) of the dataset may be provided as an input to the encoder 561 through the first stream. In an example, the third type (e.g., categorical) of dataset may be provided as an input to the encoder through the second stream. However, this is only an example for description, and the disclosure is not limited thereto.

In an embodiment, the detection module 1330 may identify (or generate) a privacy score for the respective data based on the mean and the standard deviation for the respective data obtained based on the one or more datasets. For example, the privacy score may indicate a privacy threat level of the corresponding data. For example, the privacy threat level may indicate a degree of sensitivity of information accessed by permission usage of the application and/or a possibility of leakage of information accessed by the permission usage of the application. In an example, as the privacy threat level increases, the degree of sensitivity of information and/or the possibility of information leakage may also increase. In an example, the privacy score, which is a standard value (or a standard score, a Z-score, or a Z-value) of a value indicated by the data, may be identified (or generated) according to the above-described Equation 1.

In an embodiment, the detection module 1330 may identify (or generate) the threshold score for the respective data included in the one or more datasets based on the output of the encoder. For example, the threshold score may be used to identify input data for generating a prompt. In an example, data having a privacy score exceeding the threshold score may be identified as input the data for generating the prompt. In another example, data having a privacy score below the threshold score may not be identified as the input data for generating the prompt. For example, a different loss function may be used to identify (or generate) the threshold score in accordance with a type of the datasets. In an example, a first loss function (e.g., binary cross entropy) may be used to obtain a first threshold score for respective data included in the first type (e.g., binary) of dataset. In an example, a second loss function may be used to obtain a second threshold score for respective data included in the second type (e.g., numerical) of dataset. In an example, a third loss function (e.g., categorical cross entropy) may be used to obtain a third threshold score for respective data included in the third type (e.g., categorical) of dataset.

In an embodiment, the detection module 1330 may provide the privacy score and the threshold score for the respective data included in the one or more datasets to the prompt generation module 1340.

In an embodiment, the electronic device 101 may include the prompt generation module 1340. The prompt generation module 1340 may identify at least one data having a privacy score exceeding the threshold score among one or more datasets obtained from the summarization module 1320. The prompt generation module 1340 may generate a prompt based on a privacy score corresponding to the identified at least one data, and/or data indicating a terminal status (e.g., a security state or a battery state). The prompt generation module 1340 may provide the generated prompt to the suggestion module 1350.

In an embodiment, the electronic device 101 may include the suggestion module 1350. The suggestion module 1350 may generate content for guiding the user to obtain (or display) a recommendation for a privacy threat based on the prompt obtained from the prompt generation module 1340. A language model (e.g., a large language model (LLM)) may be used to generate content based on the prompt. The language model may be fine-tuned using low-rank adaptation (LoRA). The suggestion module 1350 may display the generated content through the display 230.

The technical problems to be achieved in the disclosure are not limited to those described above, and any other technical problems not mentioned herein will be clearly understood by those having ordinary knowledge in the art to which the disclosure belongs.

An electronic device as described above may comprise a display. The electronic device may comprise memory, including one or more storage media, storing instructions. The electronic device may comprise at least one processor including processing circuitry. The instructions, when executed by the at least one processor individually or collectively, may cause the electronic device to, in response to detecting use of a permission by an application, obtain a first type of dataset and a second type of dataset related to the use of the permission by the application. The instructions, when executed by the at least one processor individually or collectively, may cause the electronic device to identify a first threshold score for respective data included in the first type of dataset and a second threshold score for respective data included in the second type of dataset, using a trained artificial intelligence model. The instructions, when executed by the at least one processor individually or collectively, may cause the electronic device to identify a first privacy score for the respective data included in the first type of dataset and a second privacy score for the respective data included in the second type of dataset. The instructions, when executed by the at least one processor individually or collectively, may cause the electronic device to obtain content for guiding a user to obtain a recommendation for a privacy threat based on a prompt generated using at least one data having a privacy score exceeding the first threshold score among the first type of dataset and at least one data having a privacy score exceeding the second threshold score among the second type of dataset. The instructions, when executed by the at least one processor individually or collectively, may cause the electronic device to display the content for guiding the user to obtain the recommendation for the privacy threat.

For example, the instructions, when executed by the at least one processor individually or collectively, may cause the electronic device to identify whether the application is included in an allow list for refraining from generating the content for guiding the user to obtain the recommendation for the privacy threat. The instructions, when executed by the at least one processor individually or collectively, may cause the electronic device to refrain from generating the content for guiding the user to obtain the recommendation for the privacy threat in accordance with an identification that the application is included in the allow list.

For example, the content may include a message for guiding the user to obtain the recommendation for the privacy threat, a user interface (UI) for dismissing the content, and a UI for displaying a setting screen for the permission of the application.

For example, the instructions, when executed by the at least one processor individually or collectively, may cause the electronic device to add the application to the allow list for refraining from generating the content based on obtaining user input for the user interface (UI) for dismissing the content.

For example, the instructions, when executed by the at least one processor individually or collectively, may cause the electronic device to identify the first privacy score by identifying a standard score of the respective data included in the first type of dataset. The instructions, when executed by the at least one processor individually or collectively, may cause the electronic device to identify the second privacy score by identifying a standard score of the respective data included in the second type of dataset.

For example, the instructions, when executed by the at least one processor individually or collectively, may cause the electronic device to identify a correlation value between the permission and a second permission in response to detecting use of the second permission of the application. The instructions, when executed by the at least one processor individually or collectively, may cause the electronic device to identify the first privacy score based on a standard score of the respective data included in the first type of dataset and the correlation value. The instructions, when executed by the at least one processor individually or collectively, may cause the electronic device to identify the second privacy score based on a standard score of the respective data included in the second type of dataset and the correlation value.

For example, the instructions, when executed by the at least one processor individually or collectively, may cause the electronic device to transmit, to a federated learning-based server, the prompt generated based on the at least one data having the privacy score exceeding the first threshold score among the first type of dataset and the at least one data having the privacy score exceeding the second threshold score among the second type of dataset. The instructions, when executed by the at least one processor individually or collectively, may cause the electronic device to obtain, from the federated learning-based server, the content for guiding the user to obtain the recommendation for the privacy threat.

For example, the instructions, when executed by the at least one processor individually or collectively, may cause the electronic device to generate the prompt using an output of a large language model (LLM) using the first type of dataset and the second type of dataset as input data, the at least one data having the privacy score exceeding the first threshold score among the first type of dataset, and the at least one data having the privacy score exceeding the second threshold score among the second type of dataset.

For example, the first type of dataset may include data indicating whether the application is executed in a foreground while the application uses the permission, data indicating the number of executions of the application, data indicating usage time of the application, and data indicating access time for the permission of the application. The second type of dataset may include data indicating a category of the application and data indicating a trust level of the application.

For example, the trained artificial intelligence model may be a variational auto-encoder (VAE). The content may be obtained based on a large language model (LLM).

A method performed by an electronic device including a display as described above may comprise, in response to detecting use of a permission by an application, obtaining a first type of dataset and a second type of dataset related to the use of the permission by the application. The method may comprise identifying a first threshold score for respective data included in the first type of dataset and a second threshold score for respective data included in the second type of dataset using a trained artificial intelligence model. The method may comprise identifying a first privacy score for the respective data included in the first type of dataset and a second privacy score for the respective data included in the second type of dataset. The method may comprise obtaining content for guiding a user to obtain a recommendation for a privacy threat based on a prompt generated using at least one data having a privacy score exceeding the first threshold score among the first type of dataset and at least one data having a privacy score exceeding the second threshold score among the second type of dataset. The method may comprise displaying the content for guiding the user to obtain the recommendation for the privacy threat.

For example, the method may comprise identifying whether the application is included in an allow list for refraining from generating the content for guiding the user to obtain the recommendation for the privacy threat. The method may comprise refraining from generating the content for guiding the user to obtain the recommendation for the privacy threat in accordance with an identification that the application is included in the allow list.

For example, the content may include a message for guiding the user to obtain the recommendation for the privacy threat, a user interface (UI) for dismissing the content, and a UI for displaying a setting screen for the permission of the application.

For example, the method may comprise adding the application to the allow list for refraining from generating the content based on obtaining user input for the UI for dismissing the content.

For example, the method may comprise identifying the first privacy score by identifying a standard score of the respective data included in the first type of dataset. The method may comprise identifying the second privacy score by identifying a standard score of the respective data included in the second type of dataset.

For example, the method may comprise identifying a correlation value between the permission and a second permission in response to detecting use of the second permission of the application. The method may comprise identifying the first privacy score based on a standard score of the respective data included in the first type of dataset and the correlation value. The method may comprise identifying the second privacy score based on a standard score of the respective data included in the second type of dataset and the correlation value.

For example, the method may comprise transmitting, to a federated learning-based server, the prompt generated based on the at least one data having the privacy score exceeding the first threshold score among the first type of dataset and the at least one data having the privacy score exceeding the second threshold score among the second type of dataset. The method may comprise obtaining, from the federated learning-based server, the content for guiding the user to obtain the recommendation for the privacy threat.

For example, the method may comprise generating the prompt using an output of a large language model (LLM) using the first type of dataset and the second type of dataset as input data, the at least one data having the privacy score exceeding the first threshold score among the first type of dataset, and the at least one data having the privacy score exceeding the second threshold score among the second type of dataset.

For example, the first type of dataset may include data indicating whether the application is executed in a foreground while the application uses the permission, data indicating the number of executions of the application, data indicating usage time of the application, and data indicating access time for the permission of the application. The second type of dataset may include data indicating a category of the application and data indicating a trust level of the application.

For example, the trained artificial intelligence model may be a variational auto-encoder (VAE). The content may be obtained based on a large language model (LLM).

The effects that may be obtained from the disclosure are not limited to those described above, and any other effects not mentioned herein will be clearly understood by those having ordinary knowledge in the art to which the disclosure belongs.

For one or more embodiments, at least one of the components described in one or more of the preceding figures may be configured to perform one or more operations, techniques, processes, and/or methods as described in the disclosure. For example, a processor (e.g., a baseband processor) described in the disclosure in relation to one or more of the preceding figures may be configured to operate in accordance with one or more examples described in the disclosure. For another example, circuitry associated with a user equipment (UE), a base station, a network element, and the like, as described above in relation to one or more of the preceding figures may be configured to operate in accordance with one or more examples described herein.

Any of the embodiments described above may be combined with any other embodiment (or a combination of embodiments) unless explicitly stated otherwise. An aforementioned description of one or more implementations provides examples and descriptions, but it is not intended to limit or exhaust a scope of an embodiment in a precise form disclosed. Modifications and variations may be possible in view of the above teaching or may be obtained from practicing various embodiments.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively,” as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the scope of the disclosure as defined by the appended claims and their equivalents.

What is claimed is:

1. An electronic device comprising:
a display;
memory, including one or more storage media, storing instructions; and
at least one processor including processing circuitry,
wherein the instructions, when executed by the at least one processor individually or collectively, cause the electronic device to:
in response to detecting use of a permission by an application, obtain a first type of dataset and a second type of dataset related to the use of the permission by the application,
identify a first threshold score for respective data included in the first type of dataset and a second threshold score for respective data included in the second type of dataset using a trained artificial intelligence model,
identify a first privacy score for the respective data included in the first type of dataset and a second privacy score for the respective data included in the second type of dataset,
obtain content for guiding a user to obtain a recommendation for a privacy threat based on a prompt generated using at least one data having a privacy score exceeding the first threshold score among the first type of dataset and at least one data having a privacy score exceeding the second threshold score among the second type of dataset, and
display the content for guiding the user to obtain the recommendation for the privacy threat.

2. The electronic device of claim 1, wherein the instructions, when executed by the at least one processor individually or collectively, cause the electronic device to:
identify whether the application is included in an allow list for refraining from generating the content for guiding the user to obtain the recommendation for the privacy threat; and
refrain from generating the content for guiding the user to obtain the recommendation for the privacy threat in accordance with an identification that the application is included in the allow list.

3. The electronic device of claim 1, wherein the content includes:
a message for guiding the user to obtain the recommendation for the privacy threat;
a user interface (UI) for dismissing the content; and
a UI for displaying a setting screen for the permission of the application.

4. The electronic device of claim 3, wherein the instructions, when executed by the at least one processor individually or collectively, cause the electronic device to:
add the application to the allow list for refraining from generating the content based on obtaining user input for the UI for dismissing the content.

5. The electronic device of claim 1, wherein the instructions, when executed by the at least one processor individually or collectively, cause the electronic device to:
identify the first privacy score by identifying a standard score of the respective data included in the first type of dataset; and
identify the second privacy score by identifying a standard score of the respective data included in the second type of dataset.

6. The electronic device of claim 1, wherein the instructions, when executed by the at least one processor individually or collectively, cause the electronic device to:
identify a correlation value between the permission and a second permission in response to detecting use of the second permission of the application;
identify the first privacy score based on a standard score of the respective data included in the first type of dataset and the correlation value; and
identify the second privacy score based on a standard score of the respective data included in the second type of dataset and the correlation value.

7. The electronic device of claim 1, wherein the instructions, when executed by the at least one processor individually or collectively, cause the electronic device to:
transmit, to a federated learning-based server, the prompt generated based on the at least one data having the privacy score exceeding the first threshold score among the first type of dataset and the at least one data having the privacy score exceeding the second threshold score among the second type of dataset; and
obtain, from the federated learning-based server, the content for guiding the user to obtain the recommendation for the privacy threat.

8. The electronic device of claim 1, wherein the instructions, when executed by the at least one processor individually or collectively, cause the electronic device to:
generate the prompt using an output of a large language model (LLM) using the first type of dataset and the second type of dataset as input data, the at least one data having the privacy score exceeding the first threshold score among the first type of dataset, and the at least one data having the privacy score exceeding the second threshold score among the second type of dataset.

9. The electronic device of claim 1,
wherein the first type of dataset includes:
data indicating whether the application is executed in a foreground while the application uses the permission,
data indicating a number of executions of the application, data indicating usage time of the application, and
data indicating access time for the permission of the application, and
wherein the second type of dataset includes:
data indicating a category of the application, and
data indicating a trust level of the application.

10. The electronic device of claim 1,
wherein the trained artificial intelligence model is a variational auto-encoder (VAE), and
wherein the content is obtained based on a large language model (LLM).

11. A method performed by an electronic device including a display, the method comprising:
in response to detecting use of a permission by an application, obtaining a first type of dataset and a second type of dataset related to the use of the permission by the application;
identifying a first threshold score for respective data included in the first type of dataset and a second threshold score for respective data included in the second type of dataset using a trained artificial intelligence model;
identifying a first privacy score for the respective data included in the first type of dataset and a second privacy score for the respective data included in the second type of dataset;
obtaining content for guiding a user to obtain a recommendation for a privacy threat based on a prompt generated using at least one data having a privacy score exceeding the first threshold score among the first type of dataset and at least one data having a privacy score exceeding the second threshold score among the second type of dataset; and
displaying the content for guiding the user to obtain the recommendation for the privacy threat.

12. The method of claim 11, further comprising:
identifying whether the application is included in an allow list for refraining from generating the content for guiding the user to obtain the recommendation for the privacy threat; and
refraining from generating the content for guiding the user to obtain the recommendation for the privacy threat in accordance with an identification that the application is included in the allow list.

13. The method of claim 11, wherein the content includes:
a message for guiding the user to obtain the recommendation for the privacy threat;
a user interface (UI) for dismissing the content; and
a UI for displaying a setting screen for the permission of the application.

14. The method of claim 13, further comprising:
adding the application to the allow list for refraining from generating the content based on obtaining user input for the UI for dismissing the content.

15. The method of claim 11, wherein the identifying the first privacy score and the second privacy score comprises:
identifying the first privacy score by identifying a standard score of the respective data included in the first type of dataset; and
identifying the second privacy score by identifying a standard score of the respective data included in the second type of dataset.

16. The method of claim 11, wherein the identifying the first privacy score and the second privacy score comprises:
identifying a correlation value between the permission and a second permission in response to detecting use of the second permission of the application;
identifying the first privacy score based on a standard score of the respective data included in the first type of dataset and the correlation value; and
identifying the second privacy score based on a standard score of the respective data included in the second type of dataset and the correlation value.

17. The method of claim 11, wherein the obtaining the content comprises:
transmitting, to a federated learning-based server, the prompt generated based on the at least one data having the privacy score exceeding the first threshold score among the first type of dataset and the at least one data having the privacy score exceeding the second threshold score among the second type of dataset; and
obtaining, from the federated learning-based server, the content for guiding the user to obtain the recommendation for the privacy threat.

18. The method of claim 11, wherein the obtaining the content comprises:
generating the prompt using an output of a large language model (LLM) using the first type of dataset and the second type of dataset as input data, the at least one data having the privacy score exceeding the first threshold score among the first type of dataset, and the at least one data having the privacy score exceeding the second threshold score among the second type of dataset.

19. The method of claim 11,
wherein the first type of dataset includes:
data indicating whether the application is executed in a foreground while the application uses the permission,
data indicating a number of executions of the application, data indicating usage time of the application, and
data indicating access time for the permission of the application, and
wherein the second type of dataset includes:
data indicating a category of the application, and
data indicating a trust level of the application.

20. The method of claim 11,
wherein the trained artificial intelligence model is a variational auto-encoder (VAE), and
wherein the content is obtained based on a large language model (LLM).
